(19) United States
(12) Patent Application Publication
(10) Pub. No.: US 2013/0198105 A1
(43) Pub. Date: Aug. 1, 2013

(54) Site Information and Management

(71) Applicant: SYNAPTOR PTY LTD, Belrose (AU)

(72) Inventors: Sean O'Donnell, Turlinjah (AU); Justin Strharsky, West Perth (AU); William Thiel, East Perth (AU); Stephen David Williams, Mount Lawley (AU)

(73) Assignee: SYNAPTOR PTY LTD, Belrose (AU)

(21) Appl. No.: 13/749,302

(22) Filed: Jan. 24, 2013

(30) Foreign Application Priority Data
Jan. 27, 2012 (AU) 2012900306

(51) Int. Cl. G06Q 10/00

(52) U.S. Cl. CPC G06Q 10/00
USPC 705/345

(57) ABSTRACT

In one preferred form there is provided a site information system. The site information system comprises: a management system including a team facility and a receiver facility. The team facility is associated with a number of teams; and the receiver facility is for receiving information from portable electronic devices associated with team members of the teams.

### FIELD OF THE INVENTION

In preferred forms the present invention relates to site information and management.

### BACKGROUND TO THE INVENTION

There are a number of industries that involve the management of geographical sites. Such industries include the mining industry and the manufacturing industry.

In the case of mining and manufacturing, potentially dangerous aspects of geographical sites mean that particular occupational health, safety and environment procedures must be followed by all site personnel and visitors. For this reason, in particular, personnel must generally undergo extensive training and be informed of all occupational health and safety requirements. Visitors must generally always be accompanied by authorised personnel.

It is against this background and the problems and difficulties associated therewith that the present invention has been developed. Whilst the present invention finds particular application in mining and manufacturing industries, it is envisaged that the present invention will find application in a number of other industries as well.

### SUMMARY OF THE INVENTION

According to a first aspect of preferred embodiments herein described there is provided a site information system comprising: a management system including a team facility and a receiver facility; the team facility being associated with a number of teams; and the receiver facility being for receiving information from portable electronic devices associated with team members of the teams.

Preferably the management system includes a management facility for allowing a number of managers to respectively manage one or more of the teams, the management system providing a structured manner for the managers to organise information received from the portable electronic devices associated with the team members.

Preferably the team facility includes an authorisation facility for allowing the inclusion of additional team members, the team facility being adapted to generate a respective unique team authorisation token associated with the or each team, the unique team authorisation token for facilitating ready inclusion of additional team members.

Preferably the management system includes a notification facility for sending a proximity alert to a team member of a team, when the team member is in proximity to a site that is associated with the team.

Preferably the notification facility includes an interface for updating an alert distance value substantially defining a distance, from the corresponding site, at which the team member of the site is sent the proximity alert when the team member approaches the site.

Preferably the notification facility includes an interface for receiving a time value for use in limiting the number the of proximity alerts sent to the team member in connection with the site.

Preferably the management system includes a team notification facility adapted to provide an interface allowing a notification to be sent to all team members of a selected team.

Preferably the management system includes a site facility for use in managing a number of sites; the receiver facility for receiving site observation information from the portable electronic devices associated with the team members of the teams.

Preferably the management system is adapted to permit the association of teams with sites on a many to many basis.

Preferably the management system is adapted provide an interface for listing teams associated with a selected site.

Preferably the site facility includes a site management facility for allowing the creation of new sites; and the site management facility includes a map facility for allowing a manger to define the boundaries of a site.

Preferably the map facility is adapted to provide at least a 2 dimensional top view when providing a map of the site.

Preferably the map facility is adapted to provide an interface allowing for the movement and creation of markers to define or alter the boundary of the site.

Preferably the management system includes a site observation facility for managing a number of site observations made by the team members of the teams.

Preferably the management system is adapted to provide a teams interface for listing teams, a sites interface for listing sites, and a site observations interface for listing site observations.

Preferably the management system is adapted to provide an interface for displaying a chart of site observations over time, a chart of site observation activity with respect to teams and a chart of site observation activity with respect to sites.

Preferably the site observation interface is adapted to provide a list of teams and, upon activation of a team, the site observation interface is adapted to list site observations made by the team members of the activated team.

Preferably upon activation of the site observation on the site observation interface, the site observation interface is adapted to provide detail of a site observation including location details of the site observation.

Preferably the management system is adapted to associate each site observation with a status.

Preferably the status comprises a status selected from the group of an open status, an active status and a closed status.

Preferably the site information system includes: a site observations recording facility for allowing the recording of site observations wherein the site observation recording facility includes a categorisation facility for use in categorising site observations based on predetermined site observation types.

According to a second aspect of preferred embodiments herein described there is provided a site information system comprising: a site observations recording facility for allowing the recording of site observations; the site observations recording facility including a categorisation facility for use in categorising site observations based on predetermined observation types.

Preferably the site observations recording facility comprises an application for a portable electronic device, the portable electronic device having wireless communications functionality.

Preferably the site information system includes a login facility for associating observations with team members of a number of teams.

Preferably site information system is configured to communicate with a computer system providing a management system including a team facility associated with a number of teams and a receiver facility for receiving information from portable electronic devices associated with the team members of the teams, the login facility being adapted to communicate with the team facility of the computer system to authorise the recording of site observations and to associate the recording of site observations with a team member of a team.

Preferably the login facility is adapted to require a login identifier, a login password and at least one team token identifier, with each team token identifier being associated with a particular team.

Preferably the site observations recording facility includes a site selection facility for allowing a team member of a team to select a site with which the team member and team are associated, the site observation recording facility being adapted to thereafter associated site observations with the selected site.

Preferably the categorisation facility is adapted to provide predetermined site observation activity types for characterising site observations on a relatively specific basis.

Preferably the predetermined site activity types include activities involving motor vehicles and elevated access.

Preferably the categorisation facility is adapted to permit the selection of only one site activity for a site observation.

Preferably the categorisation facility is adapted to provide hazard category types for characterising site observations to indicate the nature of the hazard associated with the site observations.

Preferably the hazard category types include electrical, environmental, and physical hazard types.

Preferably the system is adapted to allow multiple selection of hazard category types for a site observation.

Preferably the hazard category types include electrical, environmental, biological, psychological and physical hazard types.

Preferably the hazard category types include electrical, environmental, biological, psychological, physical, chemical, ergonomic and radiation hazard types.

Preferably the site observations recording facility is adapted to provide a recording interface for new observations, the recording interface being adapted to provide a list of initial heading components including an activity component, a hazard component and a threat component.

Preferably the activity component is adapted to provide access to a list of predetermined site observation activity types allowing an operator to select an activity on a relatively specific basis.

Preferably the site observations facility includes a safety conversation facility for querying whether a safety conversation is required.

Preferably the safety conversation facility provides a feedback facility for collecting information on the success of a safety conversation.

Preferably the site information system includes a follow up action facility for querying whether follow up action is required due to the nature of the observed activity.

Preferably the site observation system includes a camera facility for recording a photograph associated with a site observation.

Preferably the site observations recording facility includes a site selection facility for allowing an operator to select a site; the site observation recording facility thereafter associating site observations with the selected site, the site observations recording facility including a list facility for listing observations made in connection with a selected site.

Preferably activating a site observation from the list of site observations provides details of the site observation.

Preferably the site observations recording facility is adapted to automatically record the location of the site observation using a GPS facility.

Preferably the site observation system includes a map facility for displaying a map of all observations made by a team in connection with a selected site.

Preferably the site information system includes a team facility for allowing the association of site observations with particular teams.

Preferably the site information system includes a team token facility for allowing the ready addition of team members by using a team token identifier.

According to a third aspect of preferred embodiments herein described there is provided, a site information method comprising: providing a management system including a team facility associated with a number of teams; and receiving information from portable electronic devices associated with team members of the teams.

Preferably the site information method includes providing unique authorisation tokens associated with teams on a one to one basis to allow for the ready inclusion of additional team members using an authorisation facility.

Preferably the site information method includes sending a proximity alert to a team member of a team when the team member is in proximity to a site associated with the team.

Preferably the site information method includes setting an alert distance value substantially defining a distance, from the site, at which the team member is sent the proximity alert when the team member approaches the site.

Preferably the site information method includes setting a time value for use in limiting number the of proximity alerts sent to the team member in connection with the site.

Preferably the site information method includes providing a team notification facility adapted to provide an interface allowing a manager to send a notification to all team members of a selected team.

Preferably the site information method includes associating teams with sites, each site being associated with one or more teams.

Preferably the site information method includes permitting the association of teams with sites on a many to many basis.

Preferably the site information method includes allowing team managers to create new sites; and providing a map facility for allowing a manger to define the boundaries of a selected site.

Preferably the site information method includes providing a 2 dimensional top view of the selected site.

Preferably the site information method includes providing an interface using the map facility to allow for the movement and creation of markers to define or alter the boundary of a site.

Preferably the site information method includes receiving site observation information from the portable electronic devices associated with the team members and storing the received observation information.

Preferably the site information method includes providing a teams interface for listing teams, a sites interface for listing sites, and a site observations interface for listing observations.

Preferably the site information method includes providing a chart of site observations over time, a chart of site observation activity with respect to teams and a chart of site observation activity with respect to sites.

Preferably the site information includes forwarding site information observation to team members such that each team member is aware of observations made by other team members.

Preferably the site information method includes providing each team member with a location map of all observations made by other team members.

According to a fourth aspect of preferred embodiments herein described there is provided a site information method comprising: providing a plurality of portable electronic devices with corresponding site observations recording facilities; recording site observations using the observations recording facilities; associating the recorded observations with team members or teams; and forwarding the recorded observations.

Preferably the method includes forwarding the recorded messages to team members such that all team members are made aware of site observations made by the other team members of their teams.

Preferably the site information method includes providing categories of the observations based on predetermined observation types in the observations recording facility to allow for the ready categorisation of site observations.

Preferably the site information method includes uniquely identifying an individual using a login and password then using unique team token identifiers to associate individuals with teams.

Preferably the site information method includes allowing team members to select a site with which they are associated through team membership and then record site observations in association with the selected site.

Preferably the site information method includes providing an interface displaying predetermined observation activity types for allowing team members to characterise site observations on a relatively specific basis.

Preferably the site information method includes providing an interface for new observations, the interface providing a list of initial heading components including an activity component, a hazard component and a threat component.

Preferably the site information method includes querying whether a safety conversation is required due to the nature of a site observation.

Preferably the site information method includes obtaining feedback concerning the success of the safety conversation.

Preferably the site information method includes querying whether follow up action is required due to the nature a site observation.

Preferably the site observation method includes providing a camera facility for associating a photograph with a site observation.

Preferably the site information method includes automatically recording the location of the site observation using a GPS facility of an associated portable electronic device.

Preferably the site information method includes providing a team member with the option of displaying a map showing all observations made by a team in connection with a selected site.

According to a fifth aspect of preferred embodiments herein described, there is provided a computer readable medium having stored thereon computer executable instructions for performing a computer implemented method as per any of the above method aspects.

According to a sixth aspect of preferred embodiments herein described there is provided a computer readable medium having stored thereon computer executable instructions encoding a computer implemented system as per any of the above system aspects.

Preferably the computer-readable medium encoded with one or more facilities configured to run an application configured to carry out a number of operations to provide any one of the preceding method or system claims

Preferred embodiments of the present invention preferably provide systems and methods that:
(i) Allow for the advantageous formation of site observation teams that are able to readily share information concerning occupational health, safety and environmental aspects of a site;
(ii) Allow for the advantageous collection of information relating to a site observation at the point the site observation is made, where the observer is presented with advantageous site observation functionality on his her mobile device.
(iii) Allow for the advantageous categorisation of specific site observation activity types in combination with site observation hazard types to allow for the ready sharing, collation and analysis of site observation information.
(iv) Provide safety talk and follow up functionality to assist with addressing certain observed circumstances and behaviour.

It is to be recognised that other aspects, preferred forms and advantages of the present invention will be apparent from the present specification including the detailed description, drawings and claims.

### BRIEF DESCRIPTION OF DRAWINGS

In order to facilitate a better understanding of the present invention, several preferred embodiments will now be described with reference to the accompanying drawings, in which:

FIG. 1 provides a schematic view of a site information system according to a first preferred embodiment of the present invention;

FIGS. 2 to 22 provide illustrations of features of the site information system shown in FIG. 1;

FIG. 23 provides a schematic illustration of a site information system according to a second preferred embodiment of the present invention;

FIGS. 24 to 58 provide illustrations of features of the site information system shown in FIG. 23; and

FIG. 59 provides a schematic view of a method according to a third preferred embodiment of the present invention;

FIGS. 60 to 64 provide further schematic views of the method shown in FIG. 59; and

FIG. 64 provides a schematic view of a computer system according to another preferred embodiment of the present invention.

### DETAILED DESCRIPTION OF THE EMBODIMENTS

It is to be appreciated that each of the embodiments is specifically described and that the present invention is not to be construed as being limited to any specific feature or element of any one of the embodiments. Neither is the present invention to be construed as being limited to any feature of a number of the embodiments or variations described in relation to the embodiments.

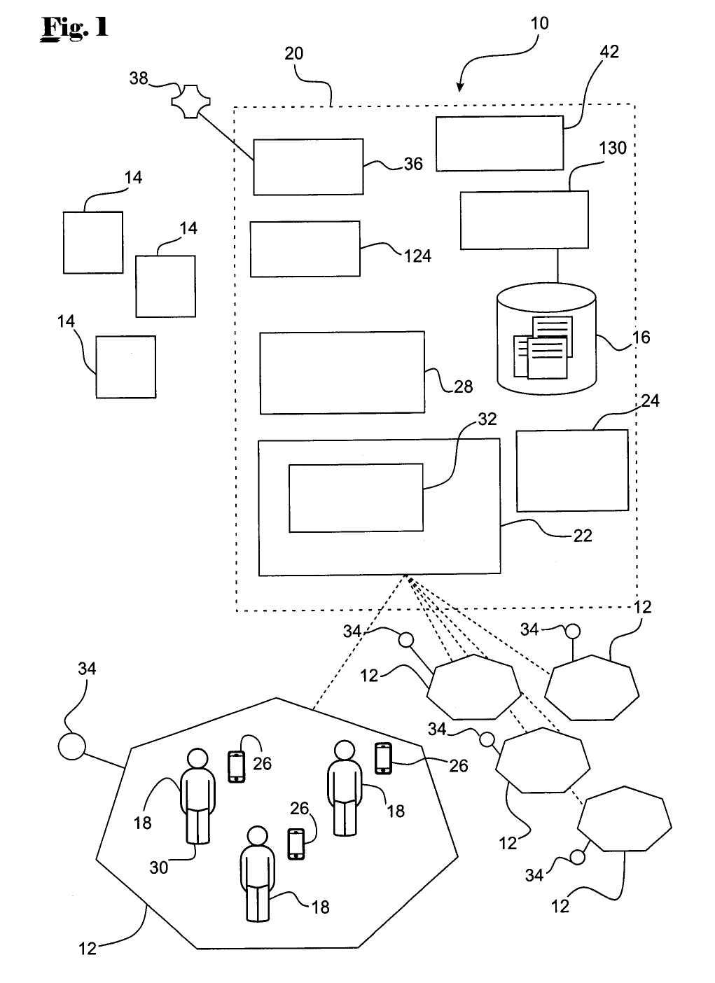

Referring to FIG. 1 there is shown a site information system 10 according to a first preferred embodiment of the present invention. The site information system 10 is considered to advantageously allow for the advantageous formation of site observation teams 12 that are able to readily share site observation information concerning occupational health, safety and environmental aspects of various sites 14. In addition the site information system 10 is considered to allow for the advantageous collation and sharing of site observation information 16 between team members 18 of the site observation teams 12.

The site information system 10 includes a management system 20 including a team facility 22 that is associated with the teams 12. The management system 20 also includes a receiver facility 24 that is adapted to receive information front the portable electronic devices 26 that are associated with the team members 18 of the teams 12.

The management system 20 includes a management facility 28 for allowing a number of managers 30 to respectively manage one or more of the teams 12. Advantageously the management system provides a structured manner for managers 30 to organise the site observation information 16 received from the portable electronic devices 26, each portable electronic device 26.

As shown in FIG. 1, the team facility 22 includes an authorisation facility 32 for allowing the inclusion of additional team members. As is described in further detail below the team facility 22 is advantageously adapted to generate a respective unique team authorisation token 34 that is uniquely associated with each team 22. The unique team authorisation tokens 34 advantageously allow the ready inclusion of additional team members and formation of teams.

The management system 10 further includes a notification facility 36 for sending proximity alerts 38 to team members 18, when one of the team members 18 is in proximity to a site 14 that is associated with the team 12 of the team member 18.

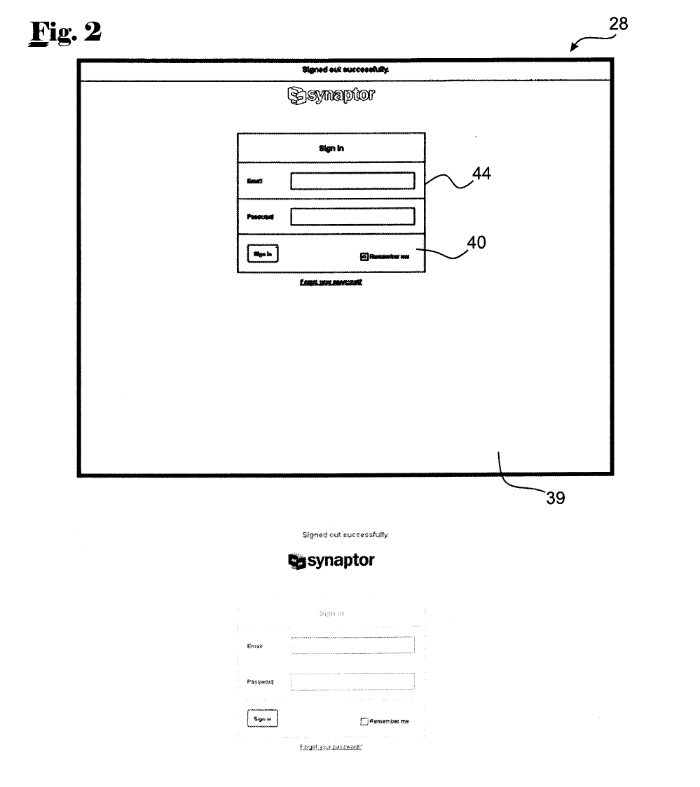

A management interface 39 of the management facility 28 is illustrated in FIG. 2. The management interface 39 includes a login facility 40 for receiving a login and password of a team manger 30. In this connection it is to be appreciated that more than one team member 18 of a team 12 may be a team manager 30. Furthermore in some embodiments each team member 18 may be a team manager 30. The site information system 10 provides an access facility 42 for controlling access rights to the management facility 28.

After a manager 30 has provided access credentials through a login form 44, the manager 30 is provided access to a site management interface 46. The site management interface 46 provides a teams component 48 and a sites component 50. Activating the teams component 48 results in the display of a teams component interface 52. The teams component interface 52 displays a list of teams 54 that are managed by the manager. Activating one of the teams 54 on the teams component interface, to select a team 56 allows for the advantageous management of the team 56.

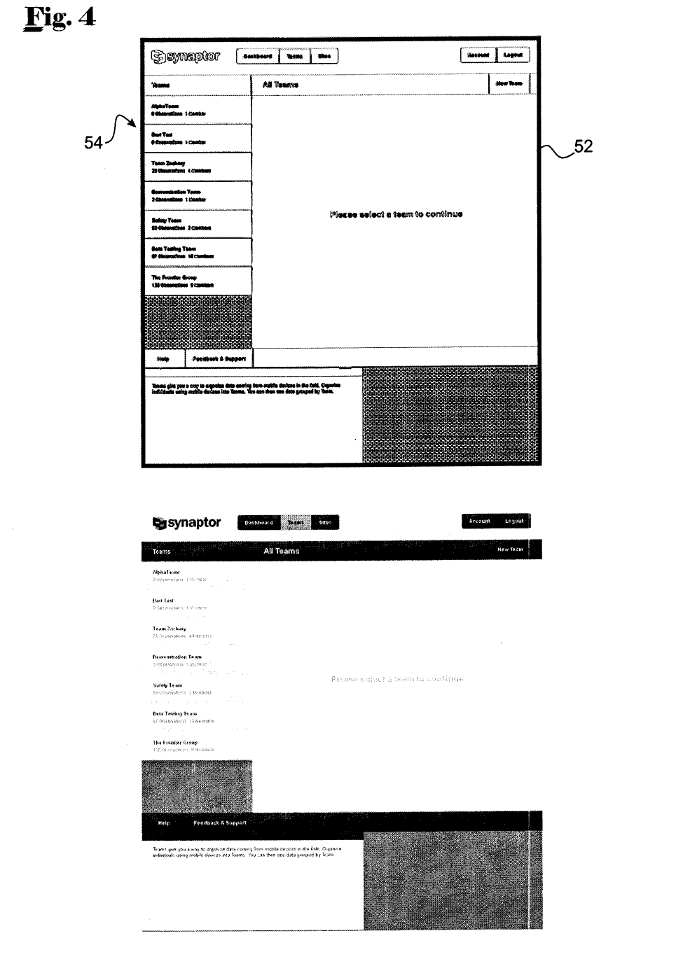

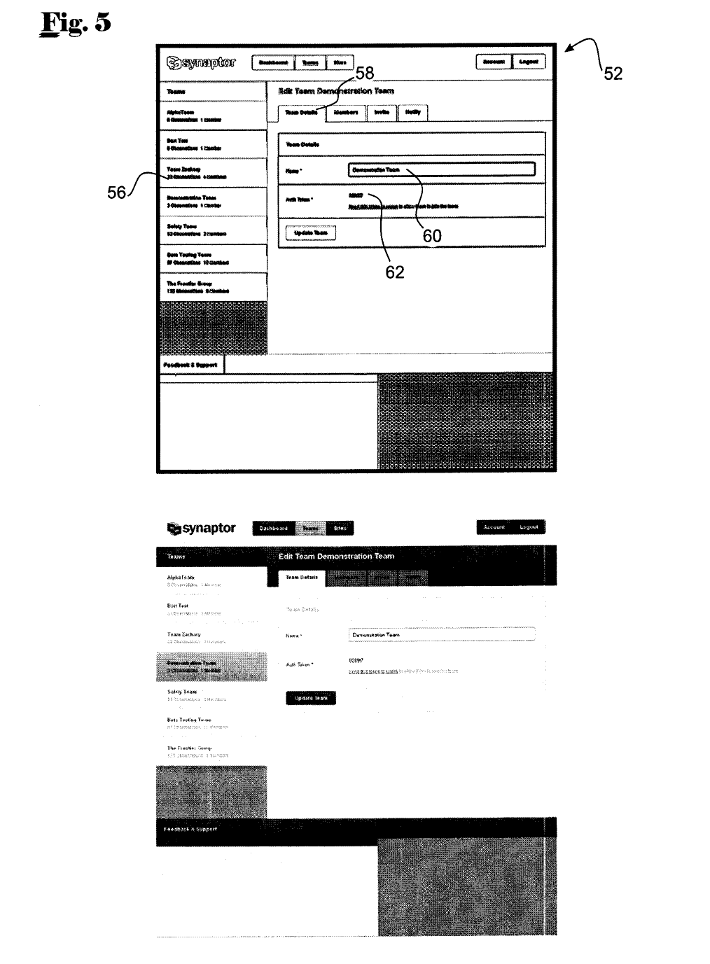

As shown in FIG. 5 this provides a team detail component 58. The team detail component 58 provides detail of a team name 60 and a team authorisation token 62, where the team authorisation token 62 is uniquely associated with the team 56. A member detail component 64 provides team member details including an email address 66 and the number of site observations 68 associated with each team member 70 of the team 56. An invitation component 72 advantageously allows for the manger to send an invitation containing the team authorisation token 62 to a non-team member to invite the non-team member to the team 56. The team authorisation token 62 advantageously allows the non-team member to join the team 56 as is described in further detail below.

The teams component interface 52 provides access to a message component 74. The message component 74 forms part of a team notification facility 122 and allows for a notification to be sent to all of the team members 18 of the selected team 56. Advantageously this allows for say a warning message to be sent to all team members in the event of an emergency such as a site evacuation.

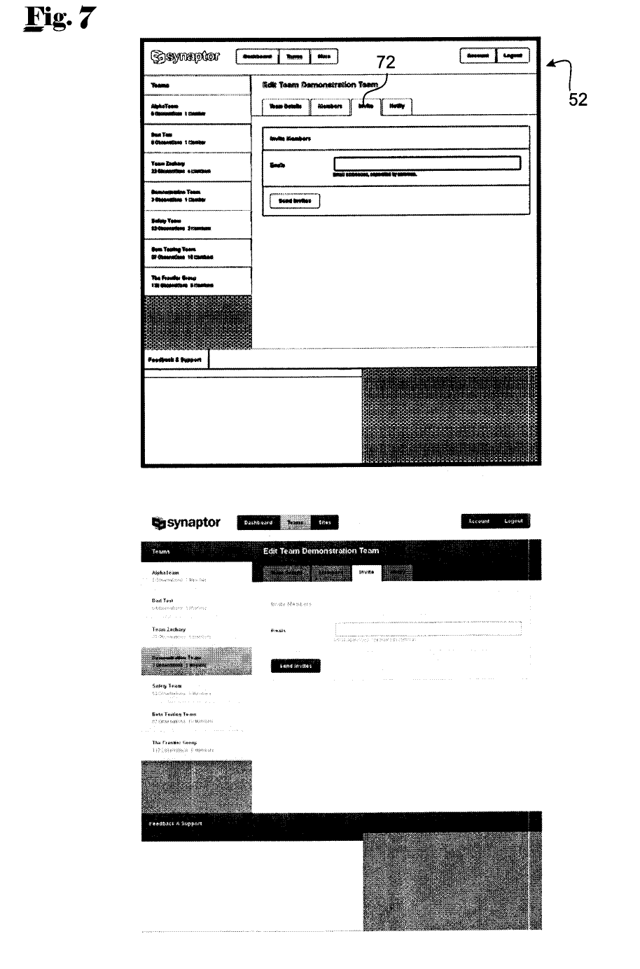

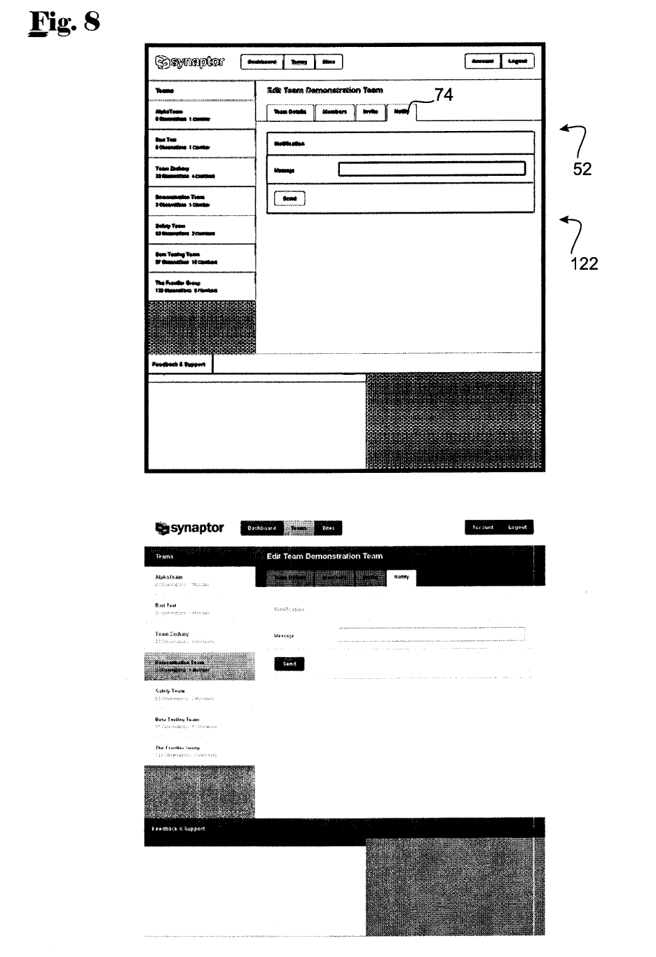

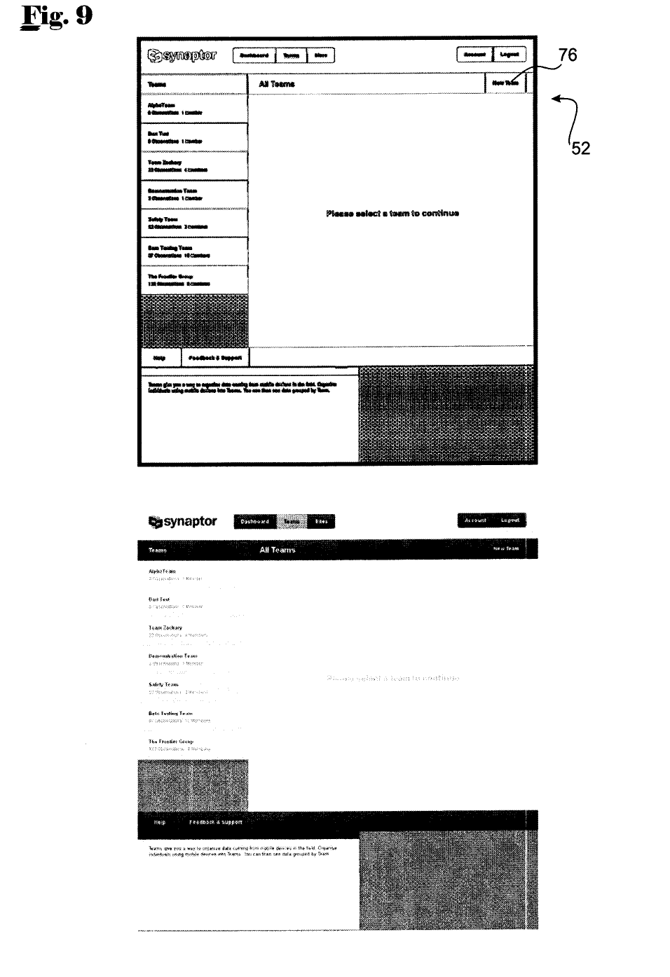

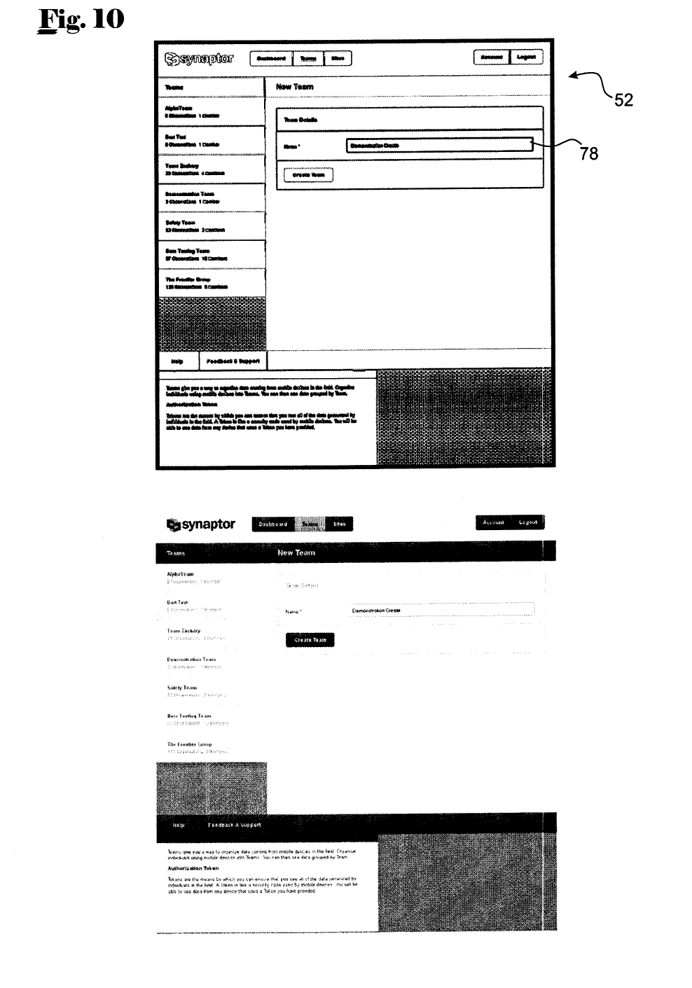

The teams component 52 allows for the creation of new teams by activating a new team component 76. Details of the new team generation method are illustrated in FIGS. 9 and 10. After inputting a team name 78, the site information system 10 automatically generates a unique team authorisation token 80 associated only with the new team.

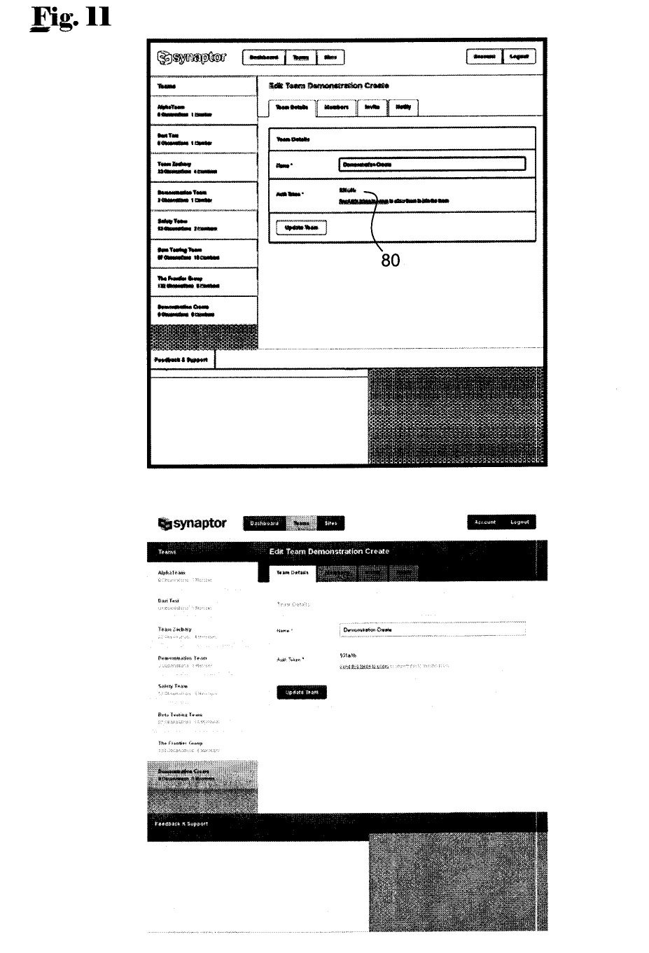

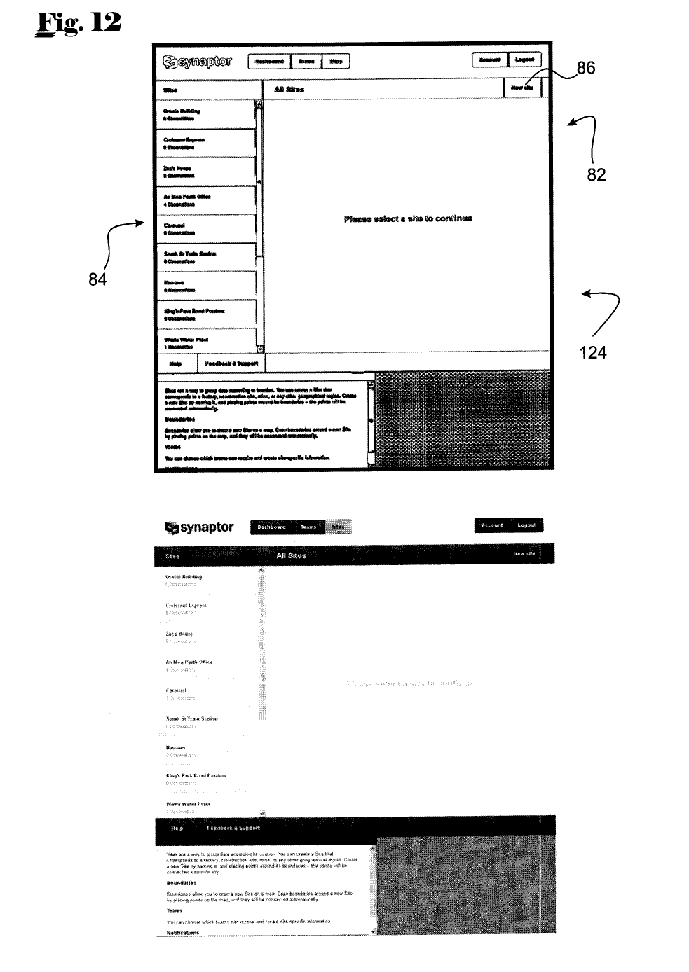

Activation of the sites component 50 provides a sites component interface 82 as shown in FIG. 12. The sites component interface 82 forms part of a site facility 124 of the site information system 10. Advantageously the sites component interface 82 lists a number of sites 84 managed by the manager. The sites component interface 82 provides a sites creation component 86. Activating a site 102 listed by the sites component interface 82 returns a site interface 88. The site interface 88 advantageously provides a detail component 94, a site boundaries component 96, a teams component 98 and a notifications component 100. Each of the components is provided as a tab on a header 104.

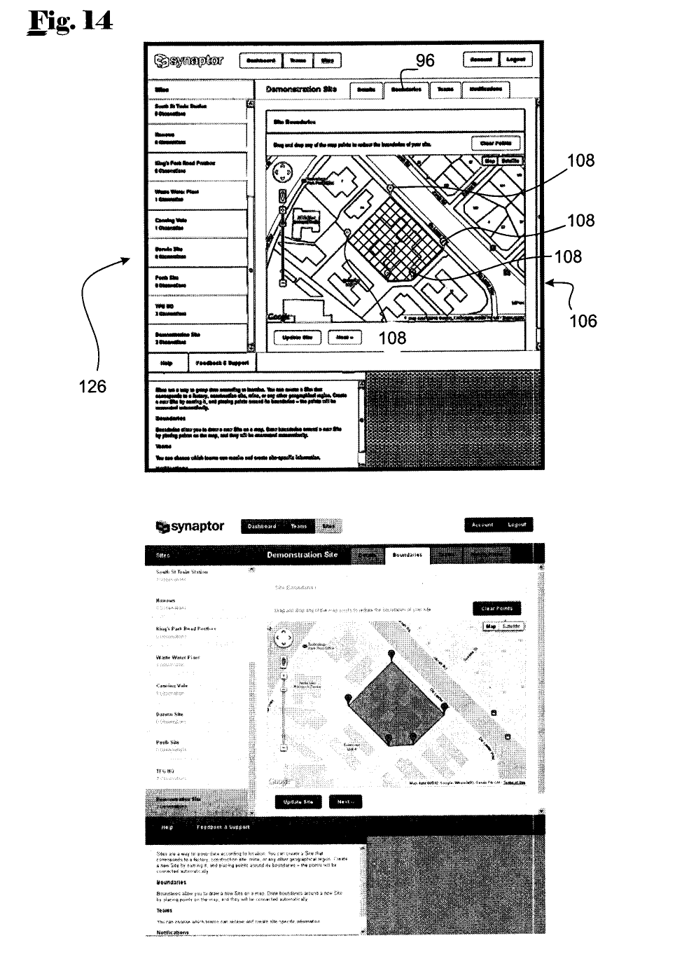

The details component 94 advantageously details the site name 92 and notes a primary contact 90 associated with the site 102. The site boundaries component 96 advantageously provides a site boundary definition facility 106 that allows for the boundary of the site 102 to be defined by placing markers 108 on a map 126 provided by the site boundary definition facility 106. As shown in FIG. 14 the site boundary definition facility provides the map 126 in the form of a two dimensional top view map. The interface advantageously allows for the movement and creation of markers to define or alter the boundary of the site 102.

The teams component 98 provides a list 110 of teams that are able to be associated with the site 102. Advantageously the manager is able to select the teams the user wishes to associate with the site 102. It is advantageously possible to associate many teams with a single site where the site boundaries and other aspects need only be specified the once, rather than for each team. Teams 12 and sites 14 can advantageously be associated on a many to many basis.

The notifications component 100 forms part of a notification facility 112. The notifications component 100 advantageously provides an interface 114 for updating an alert distance value 116. The alert distance value 116 substantially defines a distance from the site 102 in the real world at which a team member 18 of a team 12 associated with the site 102 is sent a proximity alert when the team member 18 approaches the site 102. It is advantageously possible to specify a proximity message 118 using the interface 114. The interface 114 can also be advantageously used to specify a time value 120 for use in limiting the number of proximity alerts sent to the team member 18 in connection with the site.

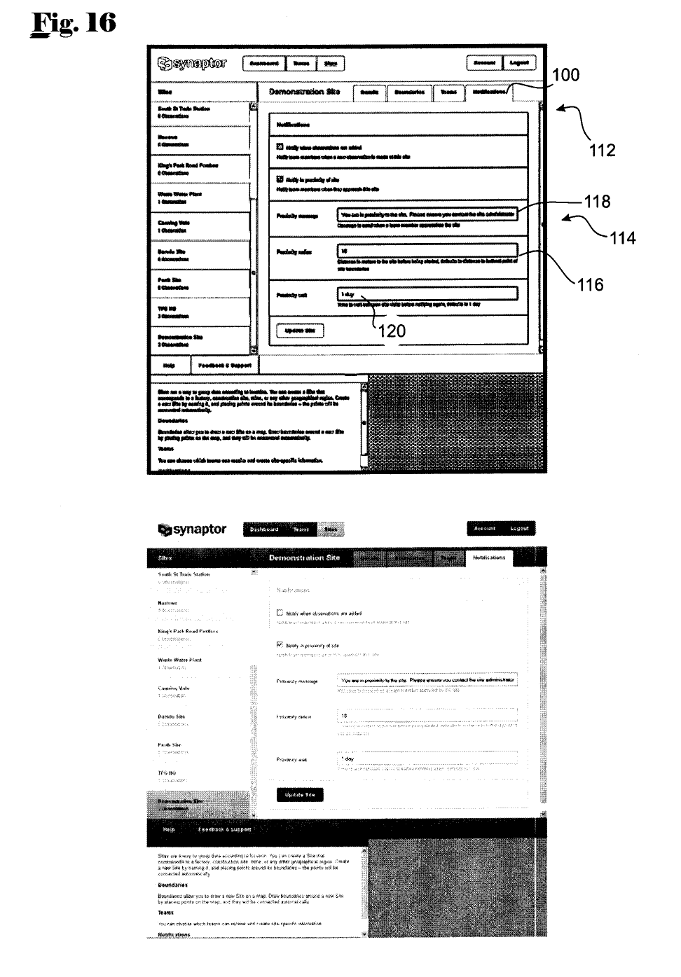

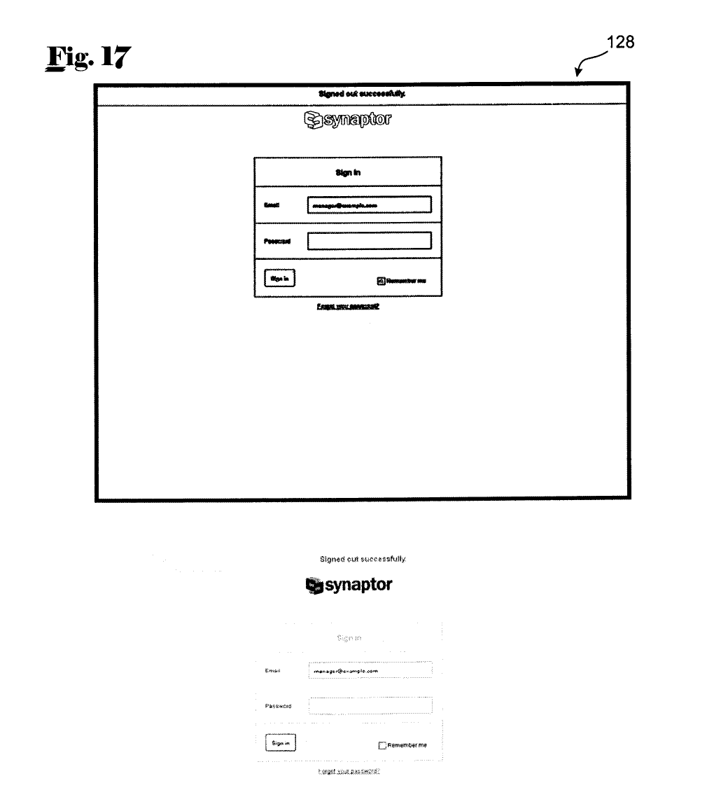

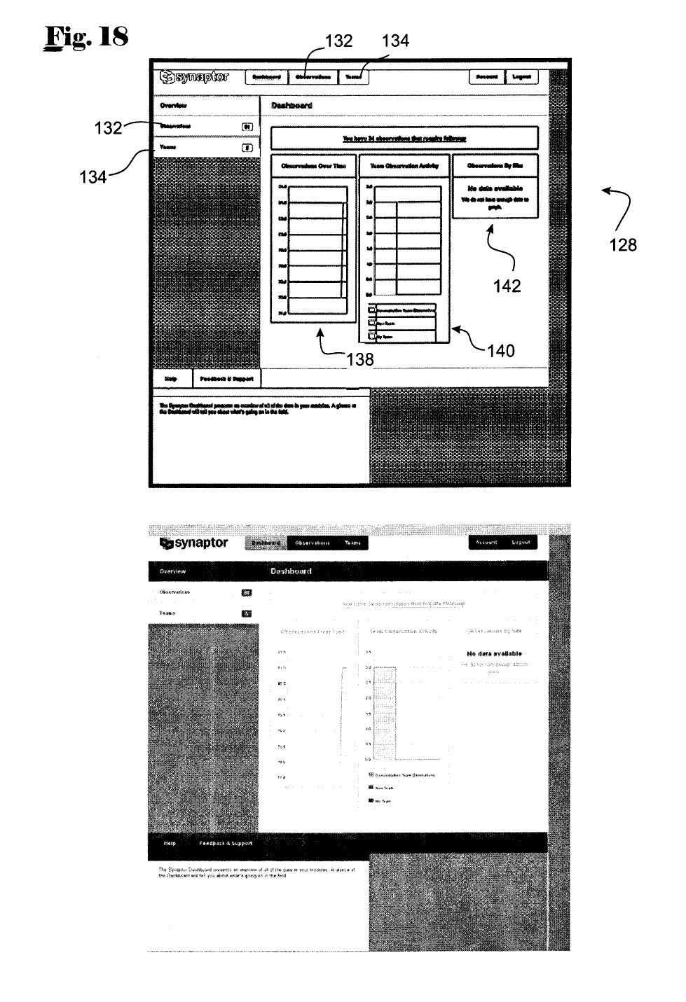

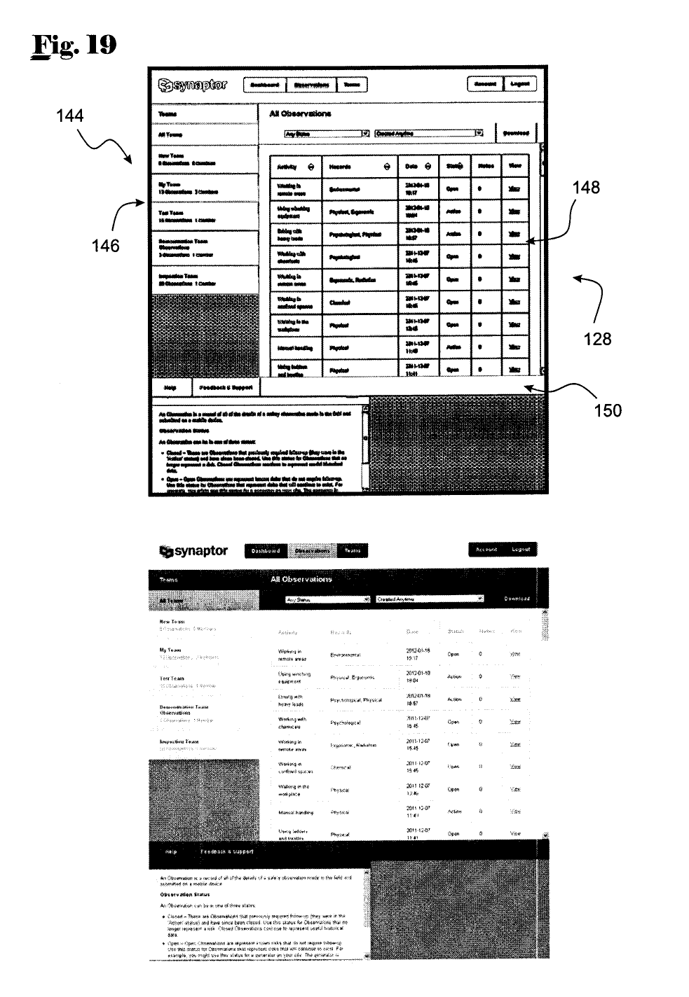

A further management interface 1 is illustrated in FIG. 17. The interface 128 makes use of a site observations facility 130 of the site information system 10. The interface 128 provides a system in which the receiver facility 24 is adapted to receive site observation information 16 from the portable electronic devices 26 associated with the team members 18 of the teams 12. The site observation facility 130 is used in the advantageous management of number of site observations made by the team members 18 of the teams 12.

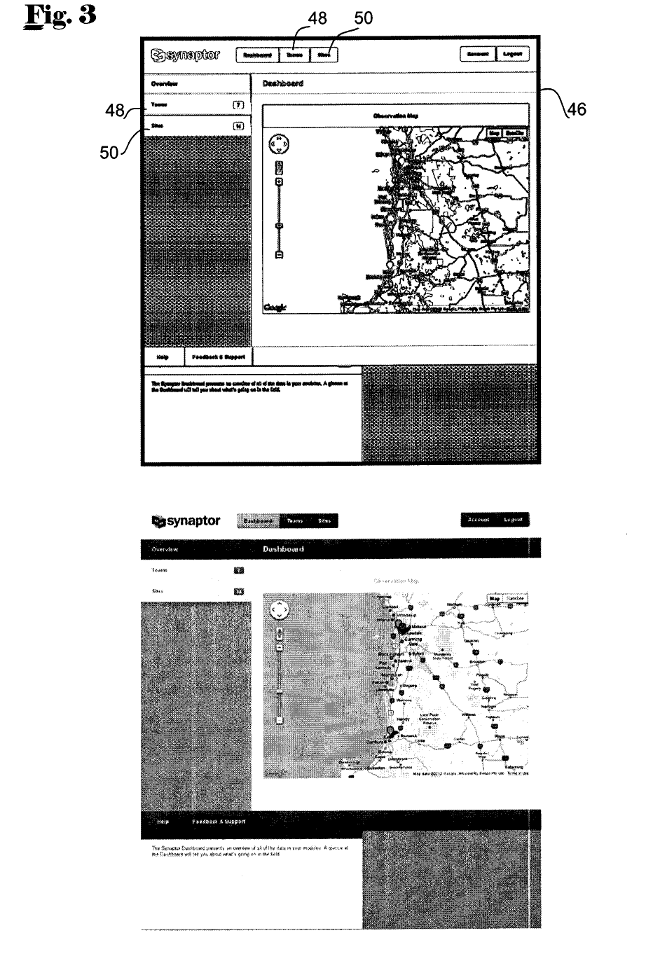

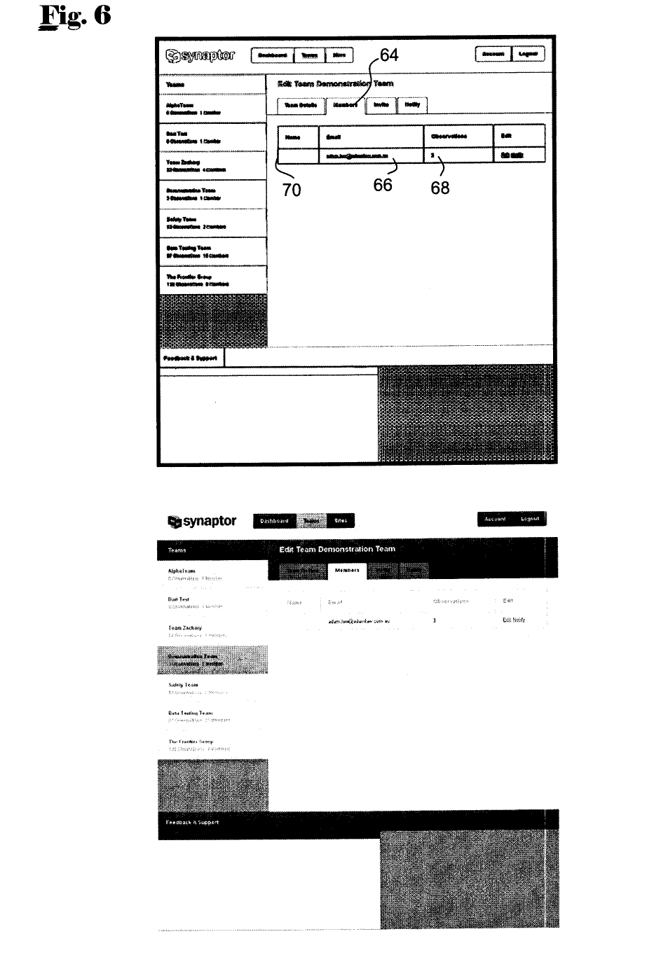

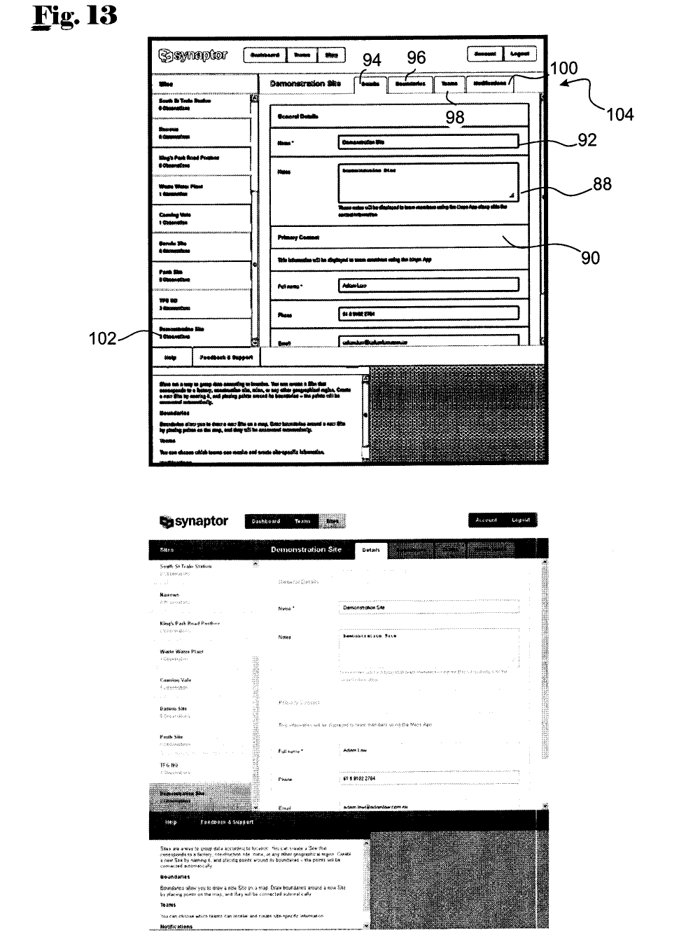

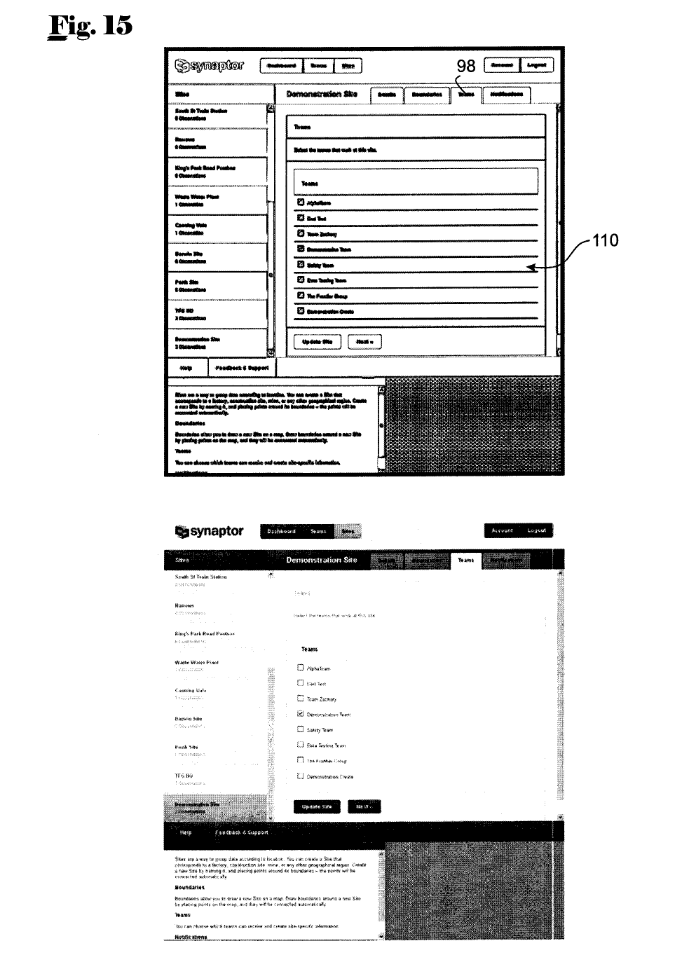

As shown in FIG. 18, the interface 128 provides access to an observations component 132 and a teams component 134. In the embodiment the interface 128 is limited to a single site, in other embodiments, such as the embodiment illustrated in FIG. 22, a sites component 136 is also provided. The sites component 136 operates with the team's component 134 in a similar manner to the operation of the teams component 48 and the sites component 50 in FIGS. 3 to 16. Generally there would be provided a teams interface for listing teams, a sites interface for listing sites, and a site observations interface for listing site observations. The example of interface 128 in FIG. 18 provides an example of a situation in which there is a single predefined site with the users of the interface 128 is not provided with a sites interface.

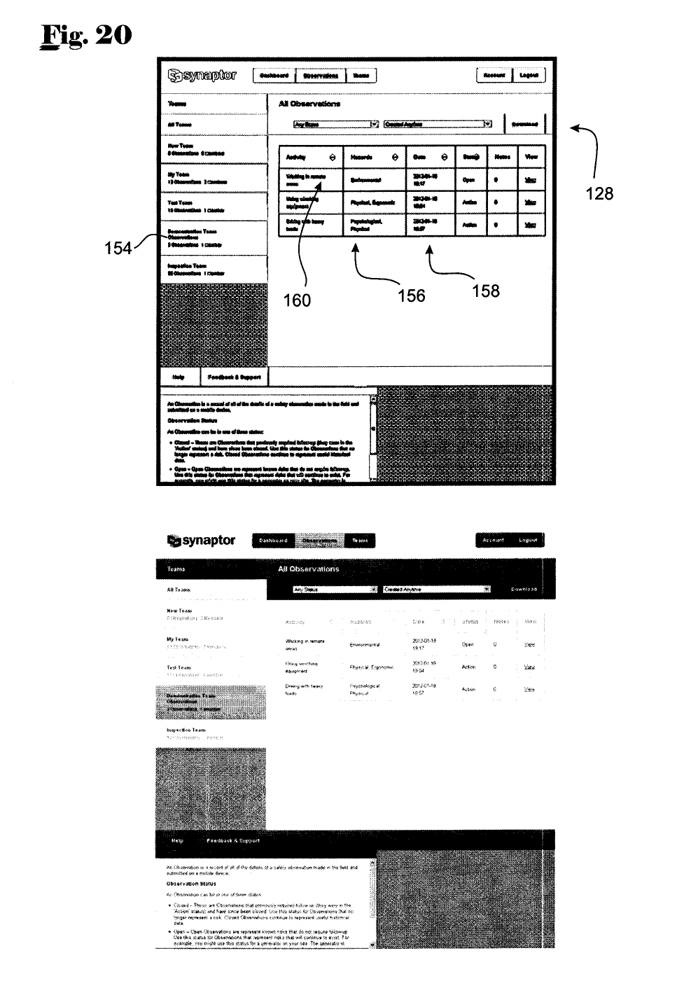

The management system 20 is adapted to provide an interface for displaying a chart of site observations over time 138, a chart of site observation activity with respect to teams 140 and a chart of site observation activity with respect to sites 142. Upon activation of the teams component 134, the interface 128 is adapted to provide a list of teams 144. The management system 20 is adapted to list all teams 144 in a list 146 and list all site observations 148 in an observation component 150, alongside the list 146. Upon activation of any one of the teams in the list 146, the site interface 128 lists site observations 152 made by the team members of the activated team. This is illustrated in FIG. 20 in which a team 154 is activated and a list 156 of site observations 158 is advantageously provided.

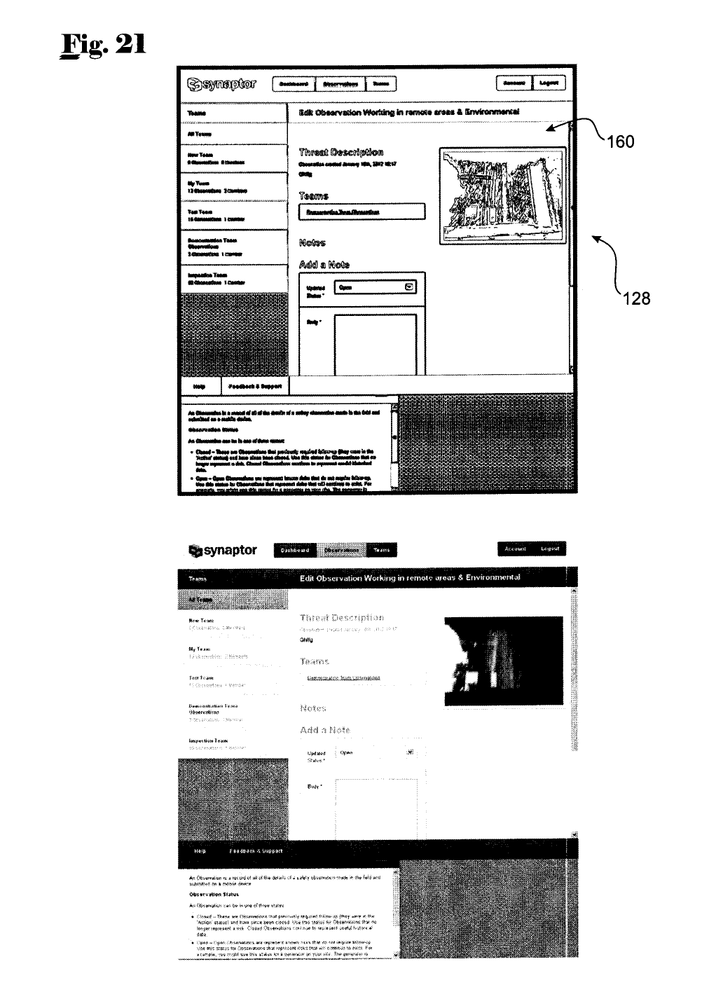

Furthermore, upon activation of any one of the site observations 158 on the interface 128, the interface 128 provides detail of the activated site observation. FIG. 21 shows an activated site observation 160. The details of the site observation 160 provided include status information where the status is either open, closed or active. A closed status is generally used for observations that previously required follow-up (i.e. they were in the ‘Action’ status) and have since been closed. The closed status is used for observations that no longer represent a risk. Closed observations are considered to continue to represent useful historical data. An open status is generally used for observations that represent known risks that do not require follow-up. Consequently an open status is used for observations that represent risks that continue to exist. In the case of a generator on a site, the generator may be associated with an electrical hazard that is may be considered to be adequately controlled. By setting the status of the site observation as open, this advantageously ensures that team members are informed of the electrical hazard. An action status generally represents observations that require follow-up. An action status is generally used to highlight observations of unsafe acts or conditions that require new additional controls. Advantageously the interface also provided details of the location of site observation 160 by showing the location of the site observation 160 on a map. The advantageous provision of location information is discussed in further detail below.

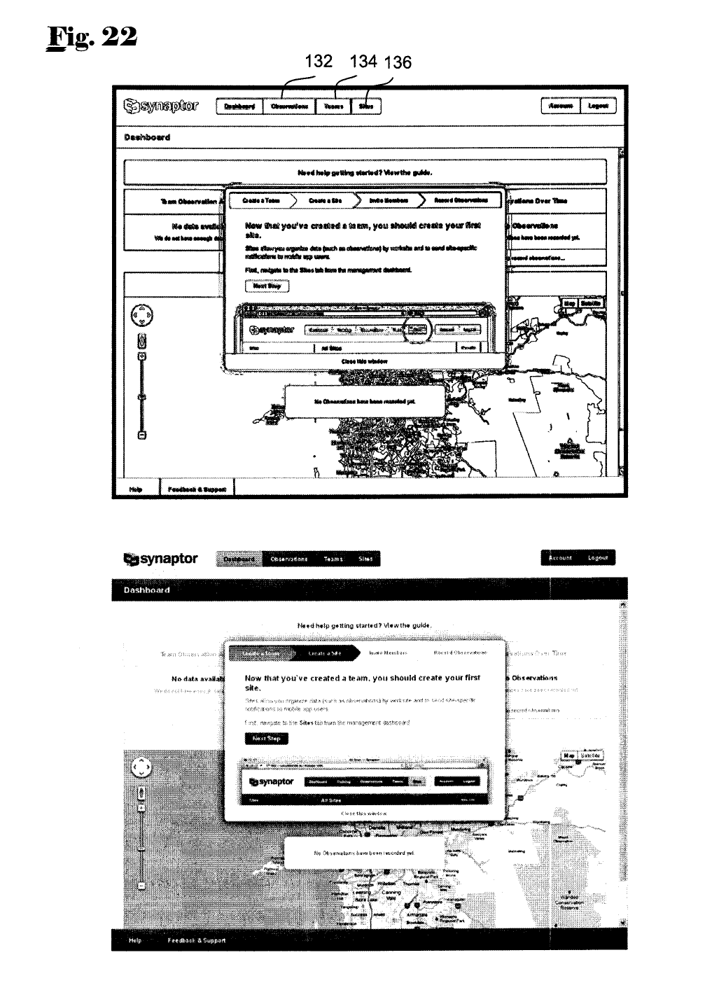

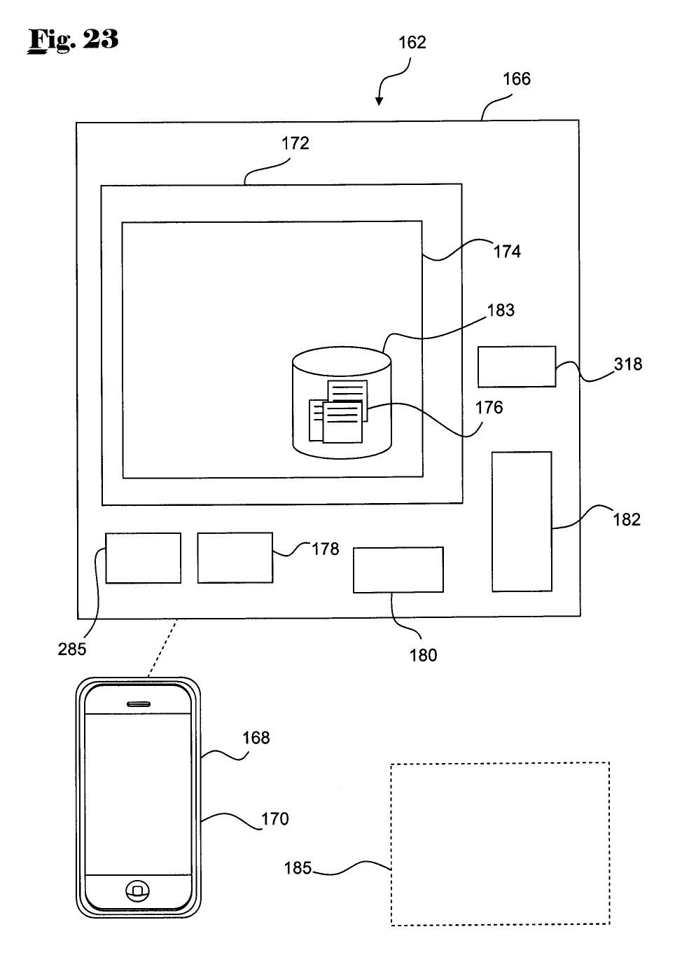

Referring to FIG. 23, there is shown a site information system 162 according to a further preferred embodiment of the present invention. The site information system 162 is provided as an application 166 for a portable electronic device 168 in the form of a mobile smart phone 170. The mobile phone 170 has wireless communications functionality providing mobile internee access and is able to communicate with a cloud based management system.

The site information system 162 includes a site observations recording facility 172 for recording of site observations. The site observations recording facility 122 includes a categorisation facility 174 for use in categorising site observations based on predetermined observation types 176.

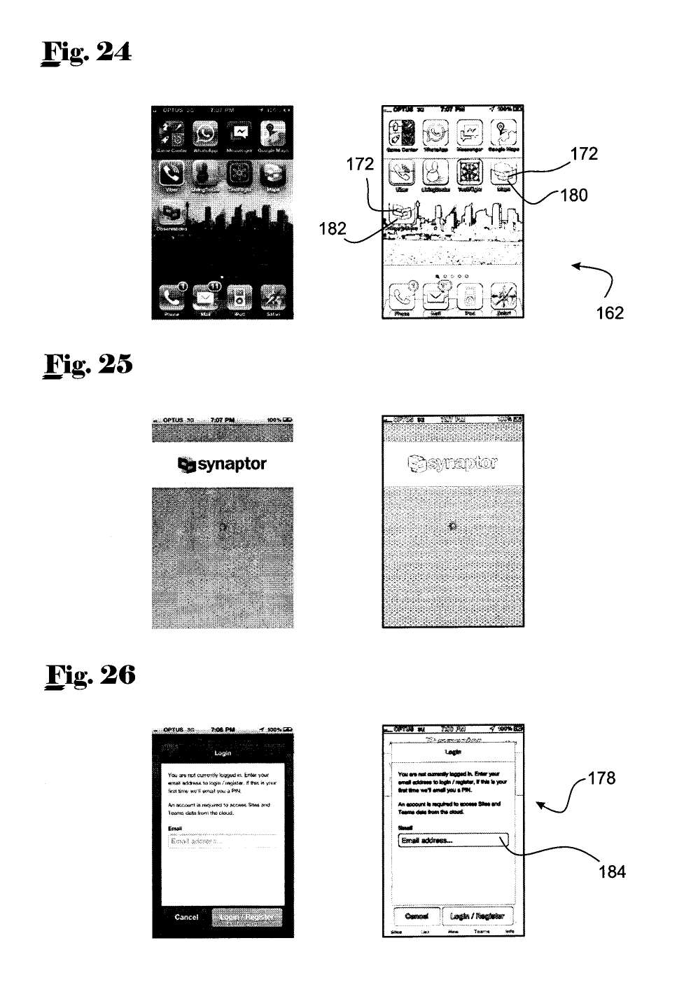

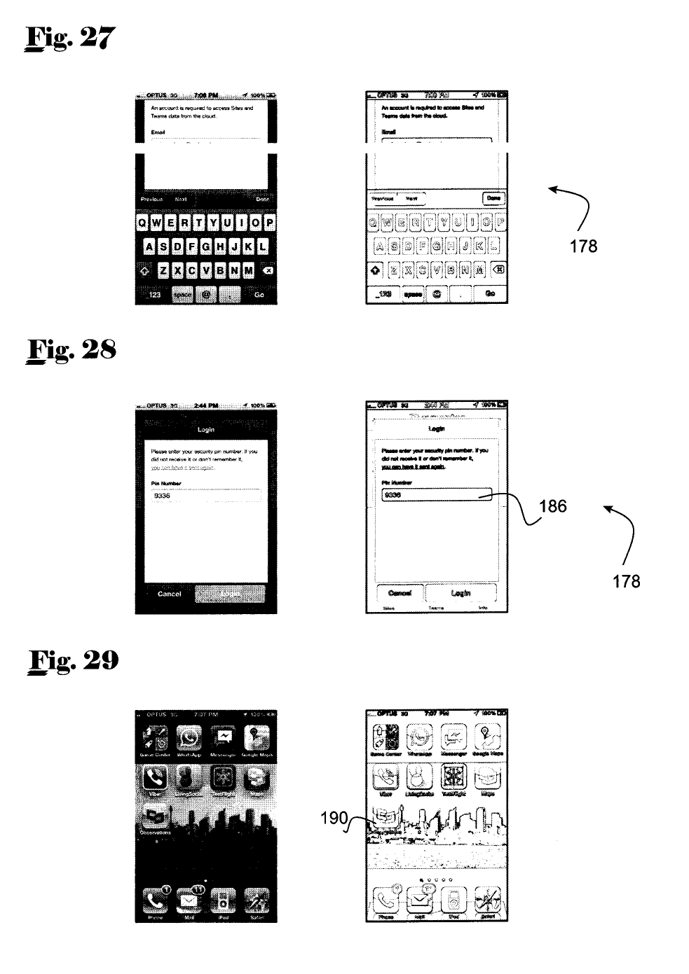

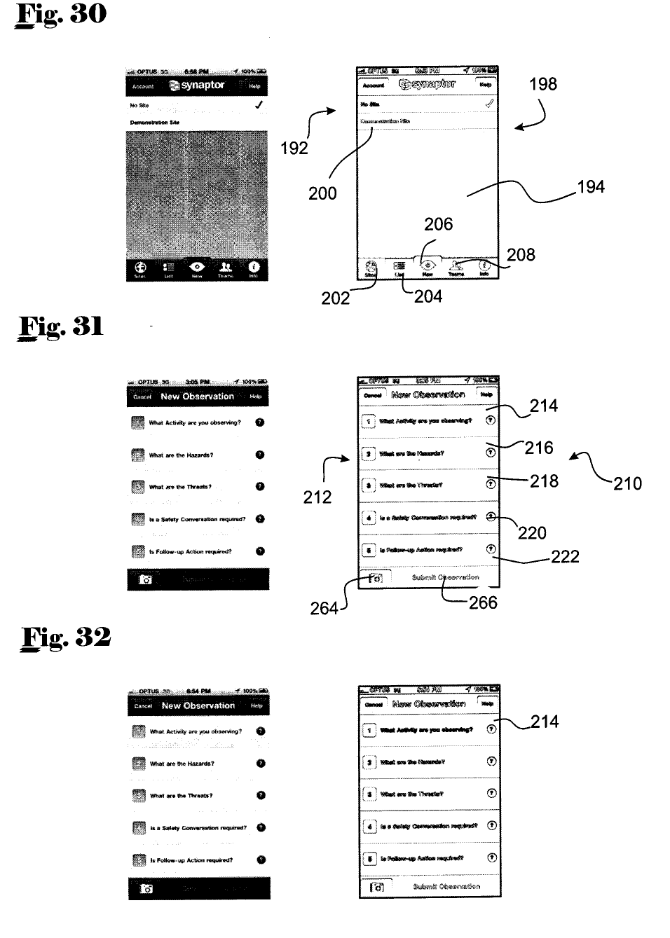

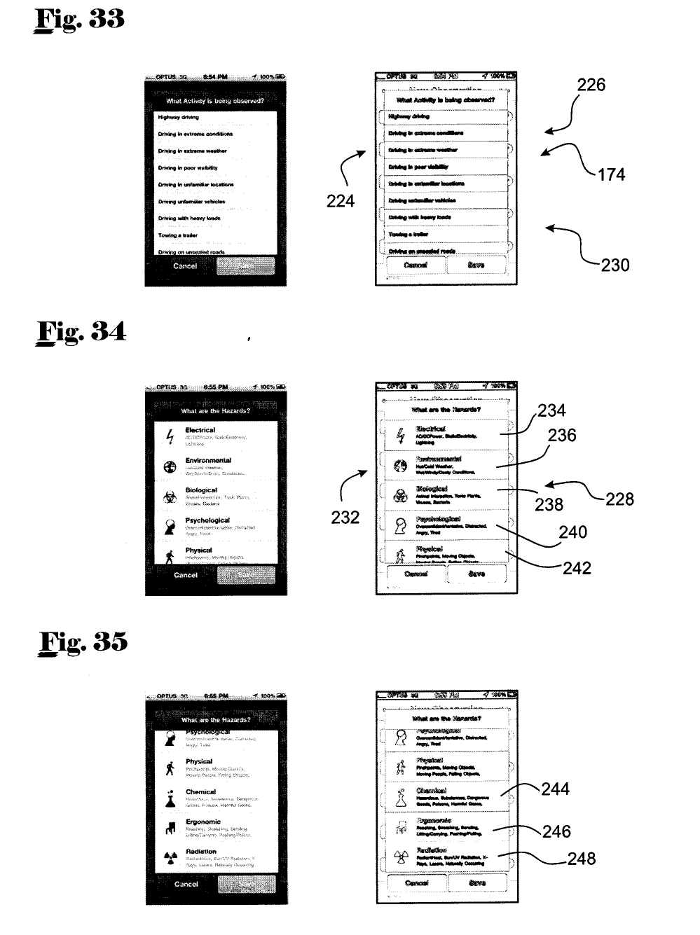

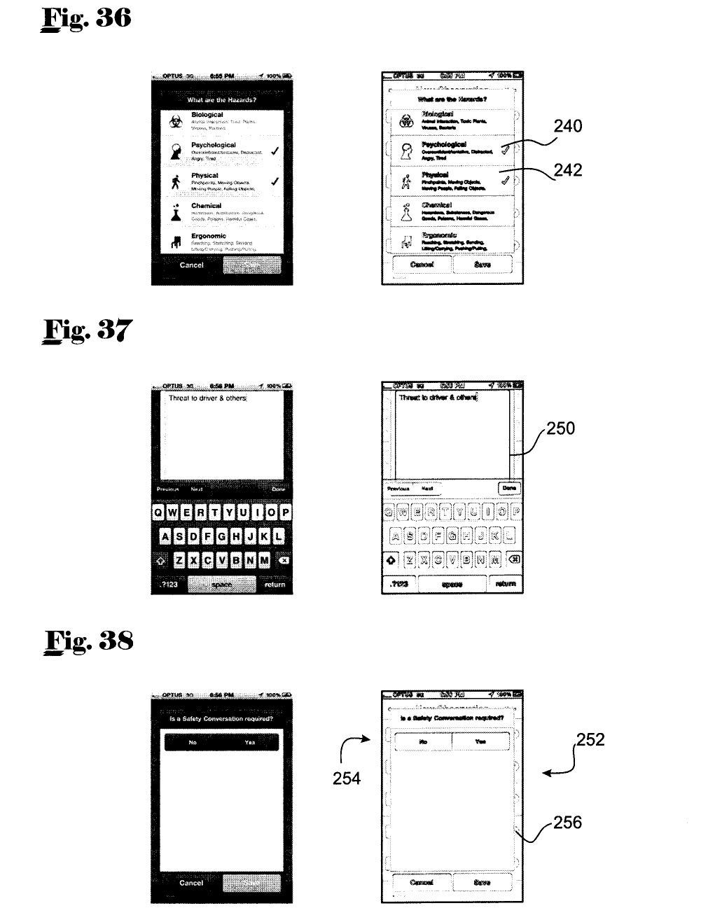

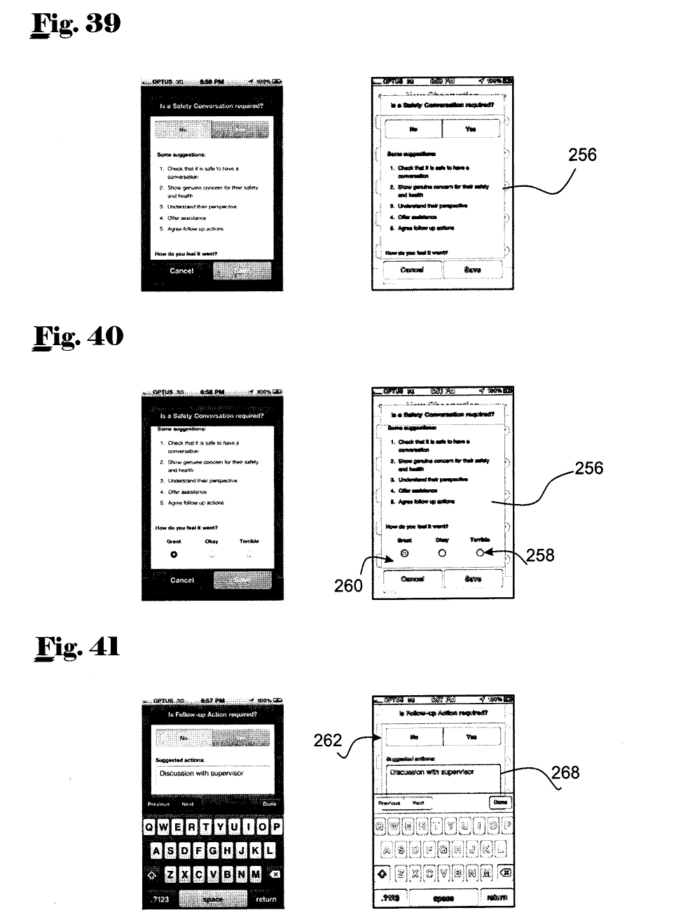

Referring to FIGS. 23 to 25, the recording facility 172 of the site information system 162 includes a login facility 178. Login details received by the login facility 178 are used for associating observations with team members of a number of teams as described below. In this manner one team member can use the mobile phone 170 and then logout allowing another team member to then use the mobile smart phone 170.

In this embodiment a maps facility 180 receives the login information and displays maps of team observations with locality information. In the embodiment an observations facility 182 is also advantageously provided. The observations facility 182 provides functionality to record, collate and list site observations. In this embodiment the maps facility 180 and the observations facility 182 are separate but cooperate by sharing site observation information from a store facility 183. In other embodiments the two facilities are combined into a single application on the mobile smart phone 170. As would be apparent facilities and the like are abstractions as different modules can be separate, joined, nested or otherwise formed.

Notably the site information system 162 is configured to communicate with a computer system 185 providing a management system including a team facility associated with a number of teams and a receiver facility for receiving information from portable electronic devices associated with the team members of the teams. In this embodiment the management system is the management system 20.

The login facility 178 shown in FIG. 26 firstly requests user identification information in the form an email address 184. The login facility 178 then requests password information in the form of a pin 186. The login facility 186 then communicates with the team facility 22 of the management system 20 to determine a unique individual identifier. The site observations recording facility 172 then receives details of all teams 12 associated with the individual, and all sites 14 associated with the teams 12. Each team 12 can be associated with many sites 14 and each site 14 can be associated with many teams 12. The individual may also be associated with several teams.

The login facility 178 authorises the recording of site observations by the team member supplying the authorised login details. After the authorised login details have been provided the site observations recordings facility 172 associates the recording of site observations with the authorised team member as part of a selected team in connection with a selected site.

Once login credentials are authorised the team member 188 using the mobile phone 170 is able to activate an observations application 190. If no site is selected then a list of sites 192 is presented within a site observations interface 194 forming part of a site selection facility 198.

The site observations interface 194 advantageously allows the team member 188 to select a site such as a site 200 with which one of the teams of the team member is associated. The site observations recording facility 172 thereafter operates to associate site observations with the selected site 200. The present applicant is envisages an setting that selectively allows the location facility to automatically present a limited list of sites 192 based on the location of the mobile phone 170 being operated by the team member.

The site observations interface 194 includes a sites component 202, a list component 204, a new site observations component 206 and a teams component 208.

Once a site is selected the new site observations component 206 can be activated to advantageously record a new site observation associated with the selected site and the selected team. Activation of the new site observations component 206 provides a recording interface 210 for new site observations. The recording interface 210 advantageously provides a list of heading components 212 including an activity component 214, a hazard component 216, a threat component 218, a safety conversation component 220 and a follow up component 222.

The recording interface 210 advantageously only allows for a sequential activation of the components 214 to 222. In this embodiment the activation order is forced to be downwardly with respect to the recording interface 210. As shown in FIG. 32 the activity component 214 must be activated first.

With the use of the categorisation facility 174, the activity component 214 is advantageously adapted to provide an activity interface 230 providing a list 224 of predetermined site observation activity types 226.

The site observation activity types 226 provided by the categorisation facility 174 are advantageously configured to allow a team member to select an activity on a relatively specific basis. In this manner the categorisation facility 172 is adapted to provide predetermined site observation activity types 226 for relatively finely characterising site observations. The examples provided in FIG. 32 include highway driving, driving in extreme conditions, driving in extreme weather, driving in poor visibility, driving in unfamiliar locations, driving with heavy loads. In this embodiment there are at least say 200 activity types 226 for characterising activities on a relatively specific basis. The characterisation is preferably configured to the extent that the activity type and date should generally be able to result in a recall of the activity. Providing a fast scrollable one dimensional list of activities is considered to allow for fast scrolling location of an activity type. The applicant is presently considering using a two dimensional list with say a driving component, an elevated activity component and second layer sub components to define the activity types. Such an arrangement provides a two dimensional list with header activation elements.

Driving activities and elevated access components are considered to be particularly advantageous for sites where contractors may drive vehicles, erect scaffolding and so forth. The present embodiment is configured for a mining site and is considered to be advantageously able to provide contractors, in their relevant teams, with an advantageous system and site observation information. Furthermore the site operator may be provided with super user access to view all observations made in connection with a particular site.

The categorisation facility 174 is adapted to permit the selection of only one site activity type 226 for a site observation. This is because the site activity types are relatively specific. If more than one activity type is required then separate site observations have to be entered into the recording interface 210.

Once a site activity type 226 has been entered, the team member is able to activate the hazard component 216 shown in FIG. 34. The hazard component 216 provides a hazard interface 228. The hazard interface 228 advantageously utilises the categorisation facility 174 to provide a list of hazard category types 232 for characterising the site observations to indicate the nature of the hazard associated with the site observation.

The list of hazard category types includes an electrical hazard type 234, an environmental hazard type 236, a biological hazard type 238, a psychological hazard type 240, a physical hazard type 242, a chemical hazard type 244, an ergonomic hazard type 246 and a radiation hazard type 248.

Advantageously the categorisation facility 174 allows multiple selection of hazard category types for a site observation. For example, as shown in FIG. 35, both the psychological hazard type 240 and the physical hazard type 242 can be selected.

Once the hazard types 232 have been selected the team member is able to use the threat component 218 to add some notes regarding the threat presented by the site observation via a threat interface 250.

Once some notes regarding the threat have been entered the team member must then activate the safety conversation component 220. A safety conversation facility 252 then presents a safety conversation interface 256 and advantageously queries whether a safety conversation is required. The safety conversation facility 252 advantageously provides a multiple choice yes/no answer component 254. Activation of a yes button provides detail of how to conduct the safety conversation. The safety conversation interface advantageously utilises a feedback facility 258 for collecting information on the success of the safety conversation. The feedback facility 258 provides a check type component 260 for collecting the relevant information.

Once the safety conversation information has been completed, the team member must activate the follow up component 222. The follow up component 222 provides a follow up interface 268 and a yes/no component 262 for querying whether follow up action is required due to the nature of the observed activity.

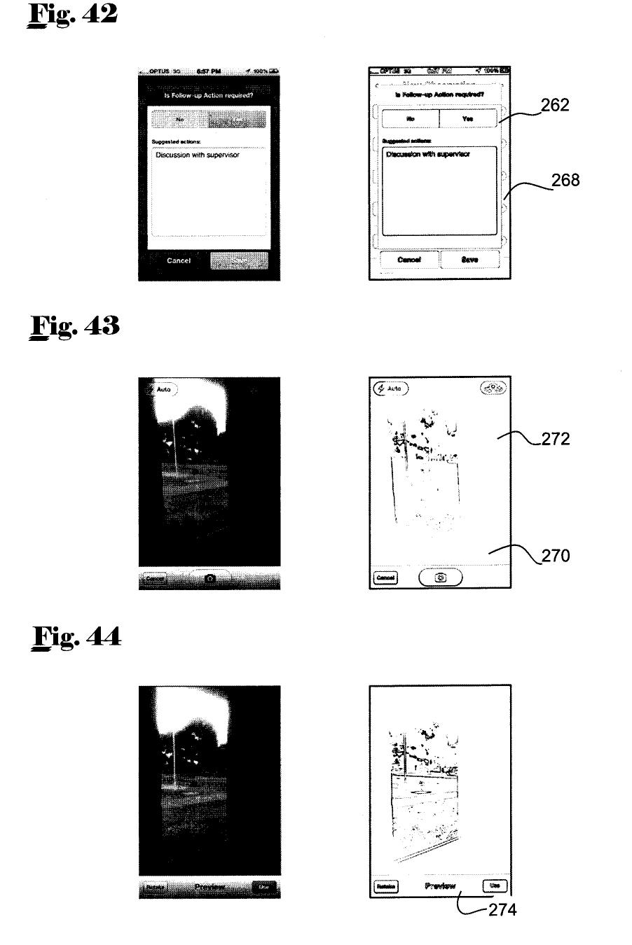

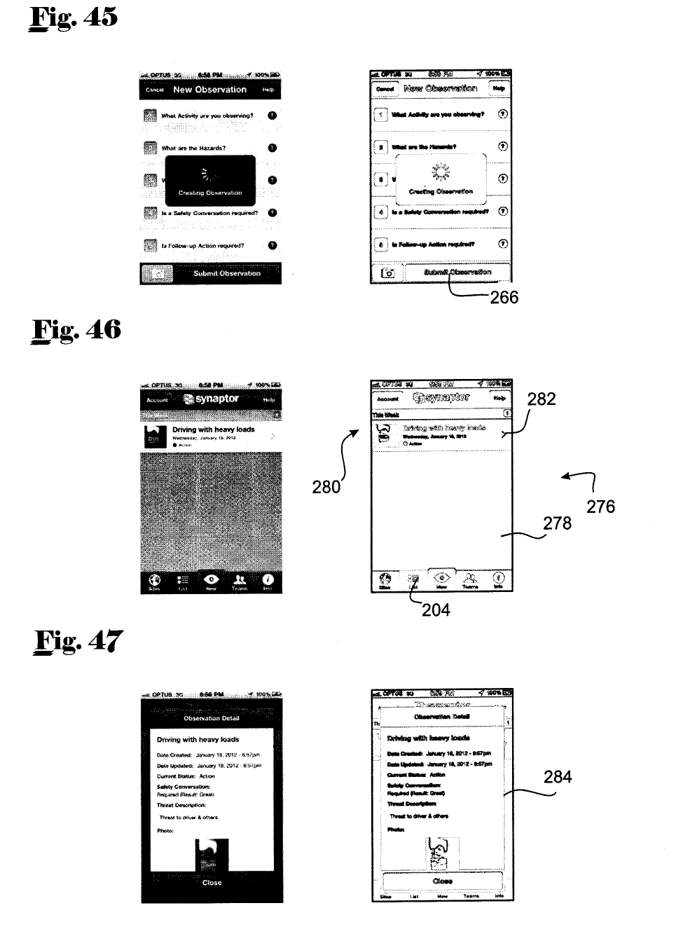

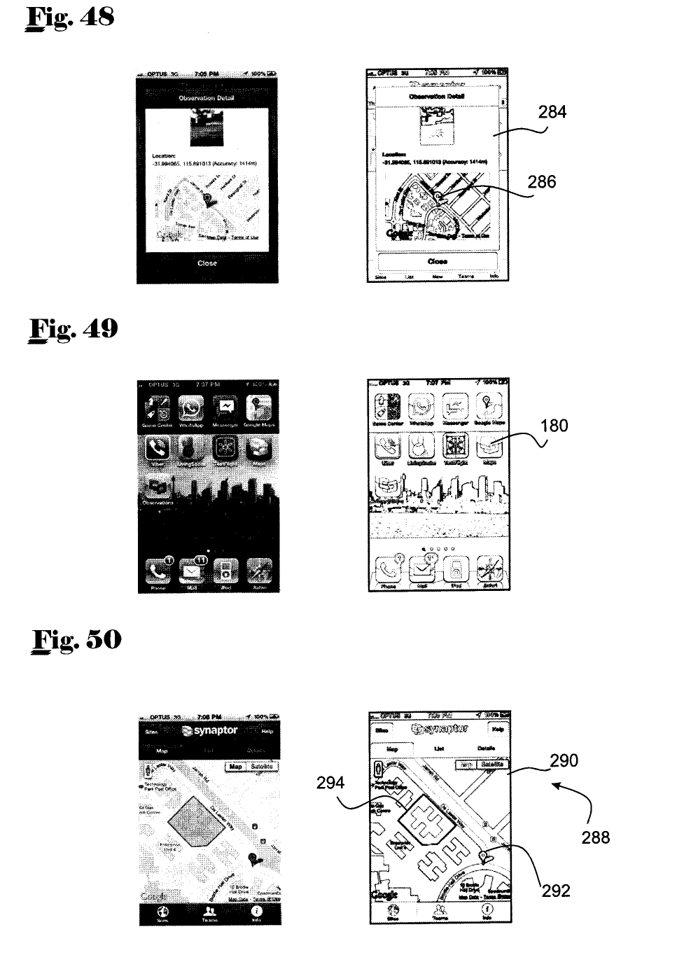

In this embodiment there is provided a camera component 264 (FIG. 31). The team member has the option of activating the camera component 264 out of sequence of the observation recording process, to record an image of the site observation being recorded (or at least an image associated with the site observation). In this manner if the opportunity presents, an image can be quickly taken. The camera component 264 is advantageously provided directly on the first screen of the recording interface 210 and can be activated at any time during the process. As shown in FIG. 42, a camera interface 270 allows the team member to take a photograph 272 and then use a preview facility 274 to either retake or accept the photograph.

Once the components 214 to 222 have been sequentially activated and their associated steps completed, the team member is able to submit the observation using a submit component 266. The submit component 266 sends the site observation to the management system 0, forming part of the overall system which advantageously distributes site observations made by team members of a team to the other team members.

As shown in FIG. 46, activation of the list component 204 activates a list facility 276 that provides a list interface 278. The list facility 276 advantageously provides a list of observations 280 made in connection with the selected site and team. Activating an observation 282 from the list of site observations 280 provides a site observation detail interface 284. Advantageously, in this embodiment, the site observations recording facility 172 is adapted to automatically record the location of the site observation using a GPS facility 285. This location is automatically submitted when the site observation activity type 226 is entered into the recording interface 210. The location 286 of the site observation is advantageously displayed by the site detail interface 284. The maps facility 180 provides access to a map facility 288 that provides a maps interface 290 for displaying a map of all observations made by a selected team in connection with a selected site. The maps interface displays a number of location markers 292 representing each site observation with respect to the site which is also illustrated by virtue of site boundaries 294. The location markers 292 are also preferably coloured according to their status and can be activated to display a site detail interface as previously described.

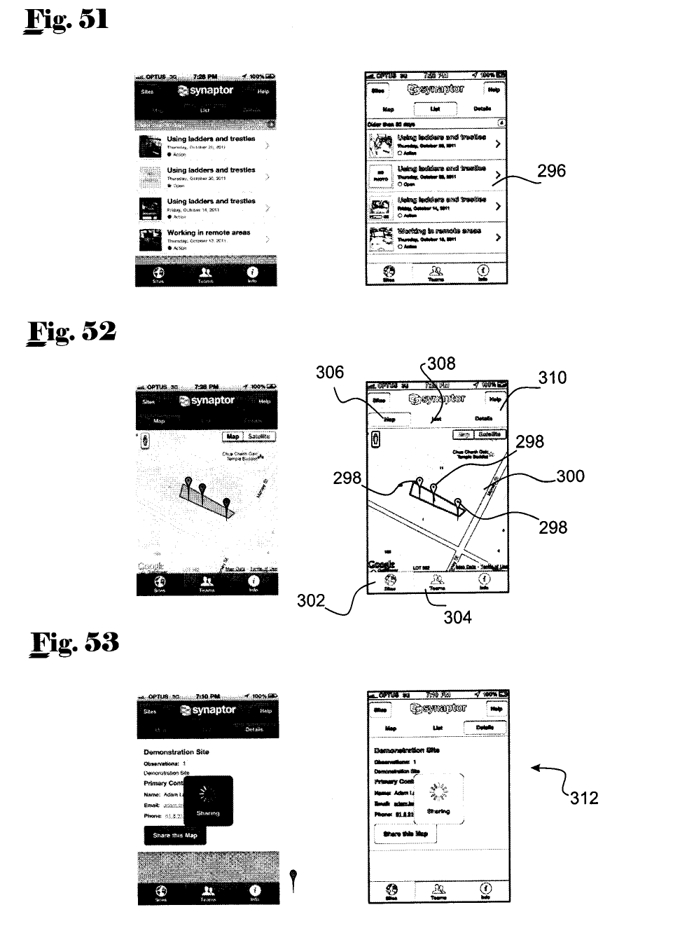

A further example of a list interface 296 is shown in FIG. 51 along with a map interface 300 having several markers 298 in FIG. 52. The markers 298 are advantageously coloured according to their status. This provides the ability for team members to relatively quickly appreciate open, closed and active site observations. In other embodiments the location of the mobile phone 170 is also detailed on the map interface.

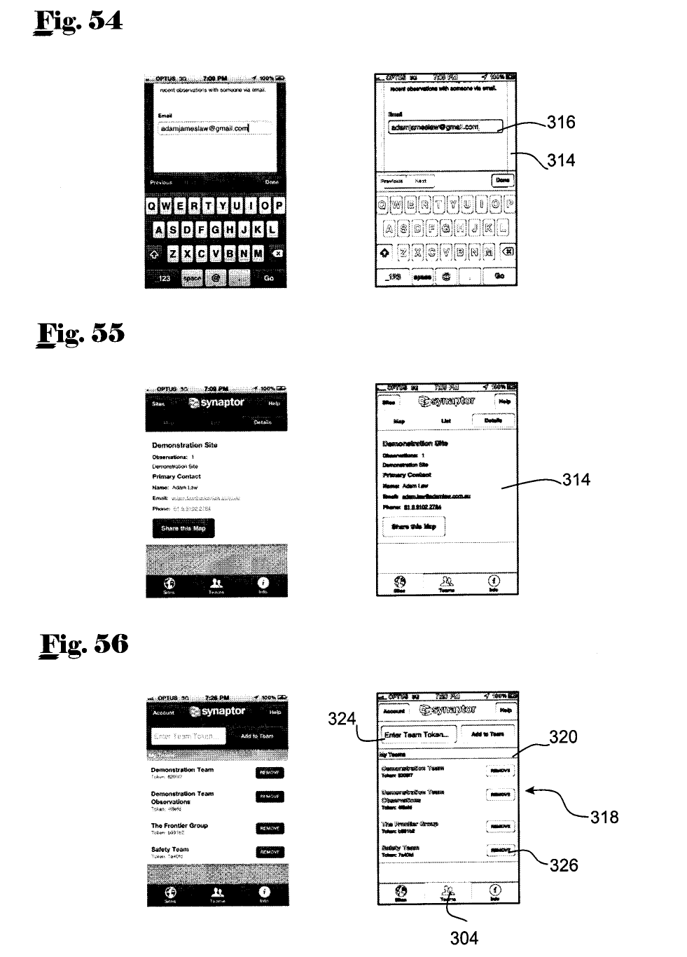

The maps facility 288 includes a maps component 302, and a teams component 304. The maps component 302 provides a map component 306, a list component 308, and a detail component 310. The map component 306 provides access to the map interface 300. The list component provides access to the list interface 296. The detail component 310 provides access to a sharing facility 312 that allows a map to be shared with a third party be email. The sharing 312 advantageously provides access to web interfaces similar to the map interface and the list interface. The operation of a sharing interface 314 provided by the sharing facility 312 is detailed in FIGS. 54 and 55. The team member first enters the email address of the third party 316 and then confirms that the site is to be shared.

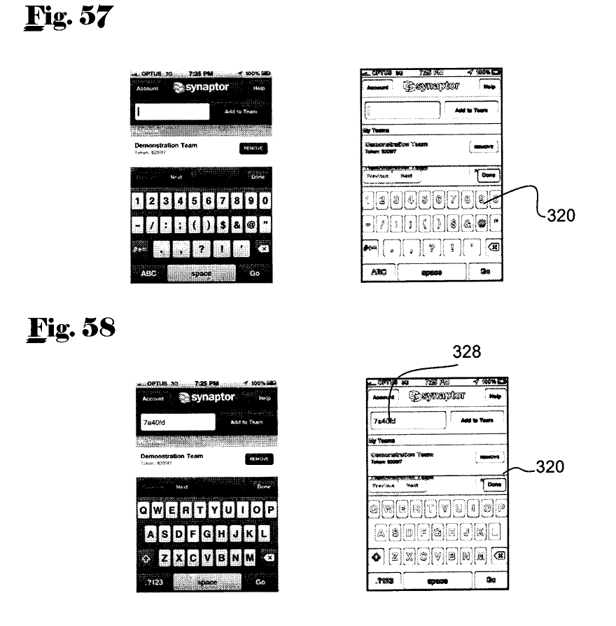

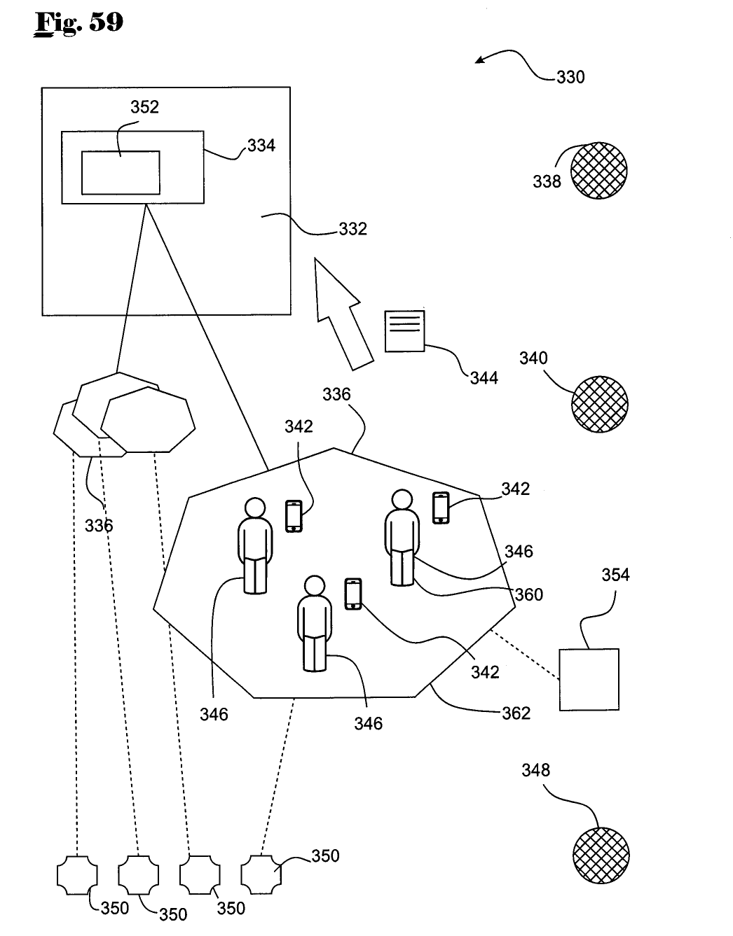

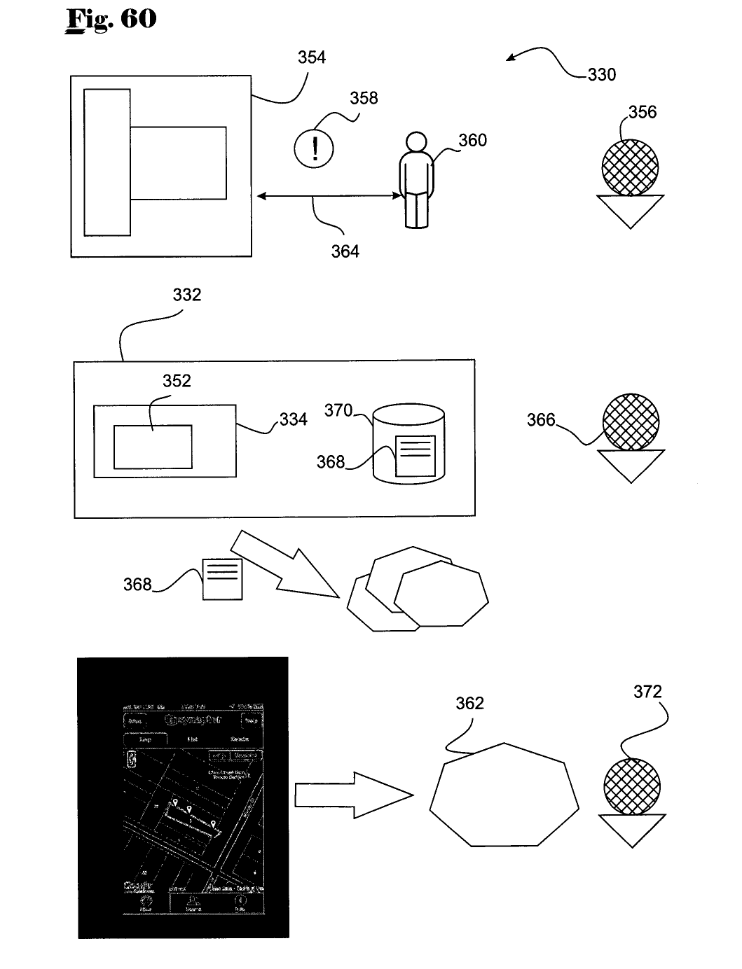

The teams component 304 forms part of a team facility 318 for allowing the team member to join particular teams. The team facility 318 provides a team interface 320 and includes a team token facility 322. The team token facility 332 allows a team token to be entered in a token component 324. When a unique team token is entered into the token component 324, the user is automatically added as a team member of the team that is uniquely associated with the team token. The team member is able to remove himself or herself from a team by activating a team removal component 326 associated with the team. As shown in FIGS. 58 and 57 an alpha numeric token 328 is entered by the team member using the mobile phone 170. The use of such tokens is considered to be advantageous in contractor environments where team members can be quickly added for site observation information collection and display.

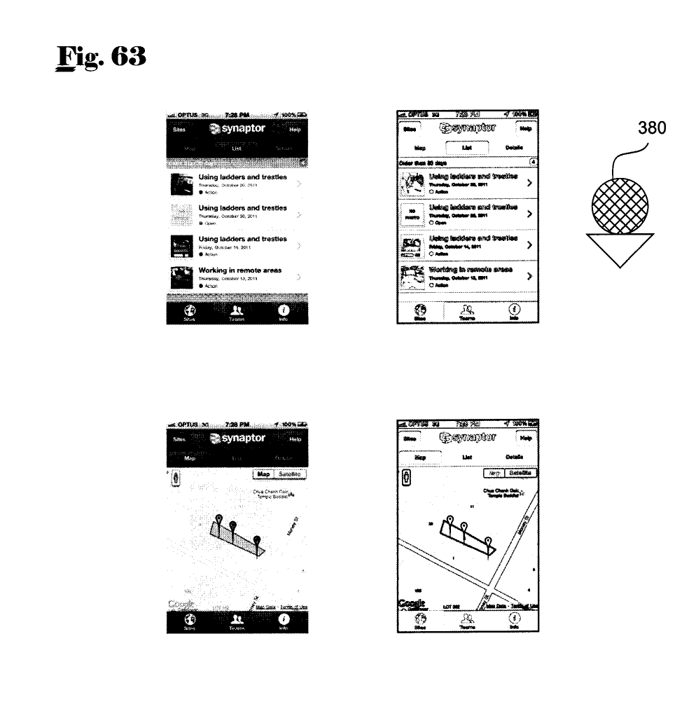

Referring to FIG. 63 there is shown a site information method 330 according to a further preferred embodiment of the present invention. At block 338 the method 330 includes providing a management system 332 including a team facility 334 associated with a number of teams 336. At block 340 the method 330 includes receiving site observation information 344 from a number of portable electronic devices 342 associated with team members 346 of the teams 336.

At block 348 the method includes providing unique authorisation tokens 350 associated with teams on a one to one basis to allow for the ready inclusion of additional team members using an authorisation facility 352 of the team facility 334.

At block 356 the method 330 includes sending a proximity alert 358 to a team member 360 of a team 362 when the team member 360 is in proximity to a site 354 associated with the team 362. An alert distance value 364 of 100 m defines the distance at which the team member 360 is sent the proximity alert 358.

At block 366 the method 330 includes forwarding site observation information 368 stored in a database arrangement 370 to team members such that each team member is made aware by being alerted to their portable electronic device 342 as a result of a push notification from the management system 332. In this manner team members are advantageously made aware of site observations made by other team members of their teams.

At block 372 the method 330 includes providing each team member of a team 362 with a location map of all observations made by other team members of the team 362.

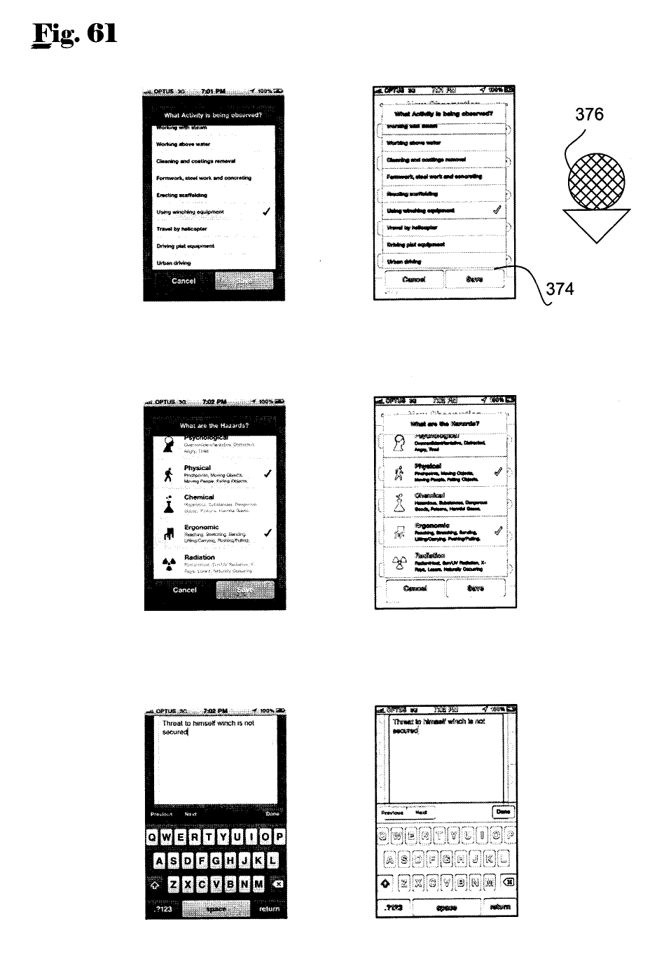

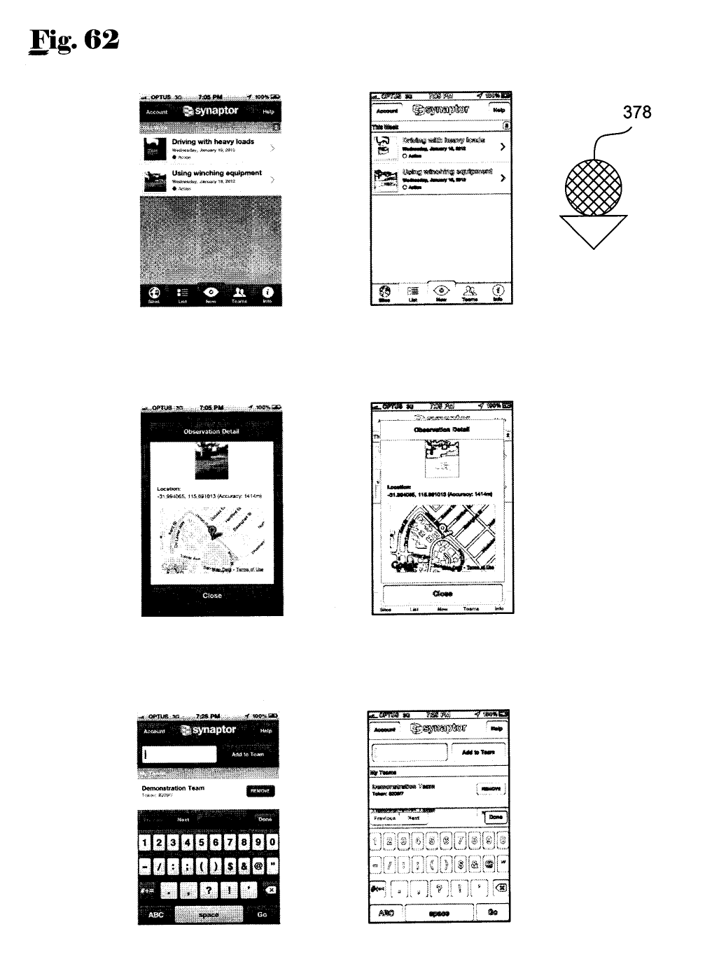

FIGS. 61 and 62 illustrate the provision of site observations recording facilities 374 and the recording of site observations using the observations recording facility 374. In the method 330 the site observation recording facilities communicate with the management system 332 and associate the recorded site observations with team members in connection with a selected team and site.

At block 376 to block 380, the method 330 proceeds in a similar manner to that previously described. Categories of the observations based on predetermined observation types are provided to allow for the ready categorisation of site observations. Logins facilities are used to uniquely identify an individual using a login and password. Team token identifiers are used to associate individuals with teams. Team members select sites with which they are associated through team membership, and then record site observations in association with the selected site. Interfaces are provided for displaying predetermined observation activity types for allowing team members to characterise site observations on a relatively specific basis. Site location information is used in automatically recording the location of the site observation using a GPS facility of an associated smart phone. Teams are advantageously provided with a map interface showing all observations made by a team in connection with a selected site.

Having now described a number of preferred embodiments of the invention it will be apparent that embodiments provide:

Preferred embodiments of the present invention preferably provide systems and methods that:
(i) Allow for the advantageous formation of site observation teams that are able to readily share information concerning occupational health, safety and environmental aspects of a site;
(ii) Allow for the advantageous collection of information relating to a site observation at the point the site observation is made, where the observer is presented with advantageous site observation functionality on his her mobile device.
(iii) Allow for the advantageous categorisation of specific site observation activity types in combination with site observation hazard types to allow for the ready sharing, collation and analysis of site observation information.

(iv) Provide safety talk and follow up functionality to assist with addressing certain observed circumstances and behaviour.

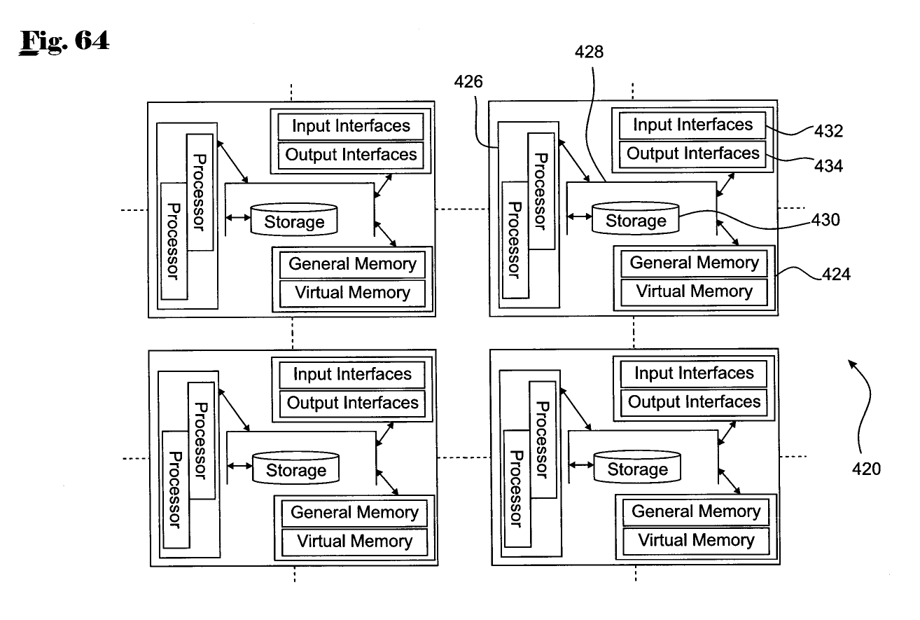

Referring to FIG. 64 there is shown a schematic diagram of a computer system 420 that is configured to provide preferred arrangements of systems and methods described herein. The computer system 420 is provided as a distributed computer environment containing a number of individual computer systems 422 (computers/computing devices) that cooperate to provide the preferred arrangements. In other embodiments the computer system 420 is provided as a single computer or another computing device.

As shown, a first one of the computing devices 422 includes a memory facility 424. The memory facility 424 includes both ‘general memory’ and other forms of memory such as virtual memory. The memory facility 424 is operatively connected to a processing facility 426 including at least one processor. The memory facility 424 includes computer information in the form of executable instructions and/or computer data. The memory facility 424 is accessible by the processing facility 426 in implementing the preferred arrangements.

As shown each of the computing devices 422 includes a system bus facility 428, a data store facility 430, an input interface facility 432 and an output interface facility 434. The data store facility 430 includes computer information in form of executable instructions and/or computer data. The data store facility 430 is operatively connected to the processing facility 426. The data store facility 430 is operatively connected to the memory facility 424. The data store facility 430 is accessible by the processing facility 426 in implementing the preferred arrangements.

Computer information may be located across a number of devices and be provided in a number of forms. For example the data store facility 430 may include computer information in the form of executable instructions and/or computer data. The computer data information may be provided in the form of encoded data instructions, data signals, data structures, program logic for server side operation, program logic for client side operation, stored webpages and so forth that are accessible by the processing facility 426.

On one level, input interfaces allow computer data to be received by the computing devices 422. On another level, input interfaces allow computer data to be received from individuals operating one or more computer devices. Output interfaces, on one level, allow for instructions to be sent to computing devices. On another level, output interfaces allow computer data to be sent to individuals. The input and output interface facilities 432, 434 provide input and output interfaces that are operatively associated with the processing facility 426. The input and output facilities 432, 434 allow for communication between the computing devices 422 and individuals.

The computing devices 422 provide a distributed system in which several devices are in communication over network and other interfaces to collectively provide the preferred arrangements. Preferably there is provided at least one client device in the system of computing devices 422 where the system is interconnected by a data network.

The client device may be provided with a client side software product for use in the system which, when used, provides systems and methods where the client device and other computer devices 422 communicate over a public data network. Preferably the software product contains computer information in the form of executable instructions and/or computer data for providing the preferred arrangements.

Input interfaces associated with keyboards, mice, trackballs, touchpads, scanners, video cards, audio cards, network cards and the like are known. Output interfaces associated with monitors, printers, speakers, facsimiles, projectors and the like are known. Network interfaces in the form of wired or wireless interfaces for various forms of LANs, WANs and so forth are known. Storage facilities in the form of floppy disks, hard disks, disk cartridges. CD-ROMS, smart card, RAID systems are known. Volatile and non-volatile memory types including RAM, ROM, EEPROM and other data storage types are known. Various transmission facilities such as circuit board material, coaxial cable, fibre optics, wireless facilities and so forth are known.

It is to be appreciated that systems, components, facilities, interfaces and so forth can be provided in several forms. Systems, components, facilities, interfaces and so forth may be provided as hardware, software or a combination thereof. The present invention may be embodied as computer readable memory, a personal computer and distributed computing environments.

In addition the present invention may be embodied as: a number of computer executable operations; a number of computer executable components; a set of process operations; a set of systems, facilities or components; a computer readable medium having stored thereon computer executable instructions for performing computer implemented methods and/or providing computer implemented systems; and so forth. In the case of computer executable instructions they preferably encode the systems, components and facilities described herein. For example a computer-readable medium may be encoded with one or more facilities configured to run an application configured to carry out a number of operations forming at least part of the present arrangements. Computer readable mediums preferably participate in the provision of computer executable instructions to one or more processors of one or more computing devices.

Computer executable instructions are preferably executed by one or more computing devices to cause the one or more computing devices to operate as desired. Preferred data structures are preferably stored on a computer readable medium. The computer executable instructions may form part of an operating system of a computer device for performing at least part of the preferred arrangements. One or more computing devices may preferably implement the preferred arrangements. The computer readable medium is preferably operatively associated with computer based transmission facilities for the transfer of computer data. Computer readable mediums may provide data signals.

Components, systems and tasks may comprise a process involving the provision of executable instructions to perform a process or the execution of executable instructions within say a processor. Applications or other executable instructions may perform method operations in different orders to achieve similar results, it is to be appreciated that the blocks of systems and methods described may be embodied in any suitable arrangement and in any suited order of operation. Computing facilities, modules, interfaces and the like may be provided in distinct, separate, joined, nested or other forms arrangement. Methods will be apparent from systems described herein and systems will be apparent from methods described herein.

It is to be recognised that various alterations and equivalent forms may be provided without departing from the spirit and scope of the present invention. This includes modifications within the scope of the appended claims along with all modifications, alternative constructions and equivalents. There is no intention to limit the present invention to the specific embodiments shown in the drawings. The present invention is to be construed beneficially to the applicant and the invention given its full scope.

In the present specification, the presence of particular features does not preclude the existence of further features. The words ‘comprising’, ‘including’ and ‘having’ are to be construed in an inclusive rather than an exclusive sense.

1. A site information system comprising: a management system including a team facility and a receiver facility; the team facility being associated with a number of teams; and the receiver facility being for receiving information from portable electronic devices associated with team members of the teams.

2. A site information system as claimed in claim 1 wherein the management system includes a management facility for allowing a number of managers to respectively manage one or more of the teams, the management system providing a structured manner for the managers to organise information received from the portable electronic devices associated with the team members.

3. A site information system as claimed in claim 2 wherein the team facility includes an authorisation facility for allowing the inclusion of additional team members, the team facility being adapted to generate a respective unique team authorisation token associated with the or each team, the unique team authorisation token for facilitating ready inclusion of additional team members.

4. A site information system as claimed in any claim 3 wherein the management system includes a notification facility for sending a proximity alert to a team member of a team, when the team member is in proximity to a site that is associated with the team.

5. A site information system as claimed in claim 4 wherein the notification facility includes an interface for updating an alert distance value substantially defining a distance, from the corresponding site, at which the team member of the site is sent the proximity alert when the team member approaches the site.

6. A site information system as claimed in claim 5 wherein the management system includes a site facility for use in managing a number of sites; the receiver facility for receiving site observation information from the portable electronic devices associated with the team members of the teams.

7. A site information system as claimed in claim 6 wherein the site facility includes a site management facility for allowing the creation of new sites; and the site management facility includes a map facility for allowing a manger to define the boundaries of a site.

8. A site information system as claimed in claim 7 wherein the management system includes a site observation facility for managing a number of site observations made by the team members of the teams.

9. A site information system as claimed in claim 8 wherein the management system is adapted to provide a teams interface for listing teams, a sites interface for listing sites, and an site observations interface for listing site observations.

10. A site information system as claimed in claim 9 wherein the management system is adapted to provide a interface for displaying a chart of site observations over time, a chart of site observation activity with respect to teams and a chart of site observation activity with respect to sites.

11. A site information system as claimed in claim 10 wherein the site observation interface is adapted to provide a list of teams and, upon activation of a team, the site observation interface is adapted to list site observations made by the team members of the activated team.

12. A site information system as claimed in claim 11 wherein upon activation of the site observation on the site observation interface, the site observation interface is adapted to provide detail of a site observation including location details of the site observation.

13. A site information system as claimed in claim 12 including: a site observations recording facility for allowing the recording of site observations wherein the site observation recording facility includes a categorisation facility for use in categorising site observations based on predetermined site observation types.

14. A site information system comprising: a site observations recording facility for allowing the recording of site observations; the site observations recording facility including a categorisation facility for use in categorising site observations based on predetermined observation types.

15. A site information system as claimed in claim 14 wherein the site observations recording facility comprises an application for a portable electronic device, the portable electronic device having wireless communications functionality.

16. A site information system as claimed in claim 15 wherein the site information system includes a login facility for associating observations with team members of a number of teams.

17. A site information system as claimed in claim 16 wherein the login facility is adapted to require a login identifier, a login password and at least one team token identifier, with each team token identifier being associated with a particular team.

18. A site information system as claimed in claim 17 wherein the site observations recording facility includes a site selection facility for allowing a team member of a team to select a site with which the team member and team are associated, the site observation recording facility being adapted to thereafter associated site observations with the selected site.

19. A site information system as claimed in claim 18 wherein the predetermined site activity types includes activities involving motor vehicles and elevated access.

20. A site information system as claimed in claim 19 wherein the categorisation facility is adapted to provide hazard category types for characterising site observations to indicate the nature of the hazard associated with the site observations.

21. A site information system as claimed in claim 20 wherein the hazard category types include electrical, environmental, and physical hazard types.

22. A site information system as claimed in claim 21 wherein the system is adapted to allow multiple selection of hazard category types for a site observation.

23. A site information system as claimed in claim 14 wherein the site observations recording facility is adapted to provide a recording interface for new observations, the recording interface being adapted to provide a list of initial heading components including an activity component, a hazard component and a threat component.

24. A site information system as claimed in claim 14 wherein the site observations facility includes a safety conversation facility for querying whether a safety conversation is required.

25. A site information system as claimed in claim 14 including a camera facility for recording a photograph associated with a site observation.

26. A site information system as claimed in claim 14 wherein the site observations recording facility is adapted to automatically record the location of the site observation using a GPS facility.

27. A site information system as claimed in claim 26 including a map facility for displaying a map of all observations made by a team in connection with a selected site.

28. A site information system as claimed in claim 27 including a team token facility for allowing the ready addition of team members by using a team token identifier.

29. A site information method comprising: providing a management system including a team facility associated with a number of teams; receiving information from portable electronic devices associated with team members of the teams; and including providing unique authorisation tokens associated with teams on a one to one basis to allow for the ready inclusion of additional team members using an authorisation facility.

30. A site information method as claimed in claim 30 including sending a proximity alert to a team member of a team when the team member is in proximity to a site associated with the team.

31. A site information method as claimed in claim 30 including providing a teams interface for listing teams, a sites interface for listing sites, and an site observations interface for listing observations.

32. A site information method as claimed in claim 31 including providing a chart of site observations over time, a chart of site observation activity with respect to teams and a chart of site observation activity with respect to sites.

33. A site information method as claimed in claim 30 including forwarding site information observations to team members such that each team member is aware of observations made by other team members.

34. A site information method comprising: providing a plurality of portable electronic devices with corresponding site observations recording facilities; recording site observations using the observations recording facilities; associating the recorded observations with team members or teams; and forwarding the recorded observations, the method including forwarding the recorded messages to team members such that all team members are made aware of site observations made by the other team members of their teams.

35. A site information method as claimed in claim 34 including uniquely identifying an individual using a login and password then using unique team token identifiers to associate individuals with teams.

36. A site information method as claimed in claim 34 including providing an interface for new observations, the interface providing a list of initial heading components including an activity component, a hazard component and a threat component.

37. A site information method as claimed in claim 34 including querying whether a safety conversation is required due to the nature of a site observation.

38. A site information method as claimed in claim 35 including obtaining feedback concerning the success of the safety conversation.

39. A computer readable medium having stored thereon computer executable instructions for performing a computer implemented method as claimed in claim 29.

40. A computer readable medium having stored thereon computer executable instructions encoding a computer implemented system as claimed in claim 1.
